(19) United States
(12) Patent Application Publication
(10) Pub. No.: US 2015/0178701 A1
(43) Pub. Date: Jun. 25, 2015

(54) KIOSK ACCOUNT MANAGEMENT SYSTEM AND METHOD

(71) Applicant: Gift Card Impressions, LLC, Kansas City, MO (US)

(72) Inventors: Brett R. Glass, Kansas City, MO (US); Karl Joseph Geisler, Olathe, KS (US)

(21) Appl. No.: 14/578,067

(22) Filed: Dec. 19, 2014

Related U.S. Application Data
(60) Provisional application No. 61/918,006, filed on Dec. 19, 2013.

(51) Int. Cl. G06Q 20/18; G06Q 30/02; G06Q 20/28; H04W 12/08; G06Q 20/20; H04W 8/26

(52) U.S. Cl. CPC G06Q 20/18; G06Q 20/202; H04W 8/265; G06Q 20/28; H04W 12/08; G06Q 30/0226; G06Q 30/0241

(57) ABSTRACT

A kiosk account management system includes a server in communication with one or more kiosk computing devices configured in kiosks. The server receives account information from a kiosk computing device in which the account information is associated with a service provided by at least one consumer item held and displayed on the kiosk. The uses the account information to facilitate management of the account with a service provider computing device administered by a provider of the service using an interactive video segment. The server also receives, from the service provider computing device, interactive video segment information for customizing the interactive video segment, and customizing the interactive video segment according to the received interactive video segment information.

### RELATED APPLICATIONS

This application takes priority to U.S. Provisional Patent Application Ser. No. 61/918,006, filed Dec. 19, 2013, and entitled “Kiosk Account Management System and Method,” the contents of which is incorporated herein by reference in its entirety.

### FEDERALLY SPONSORED RESEARCH OR DEVELOPMENT

Not Applicable.

### COMPACT DISK APPENDIX

Not Applicable.

### FIELD OF INVENTION

The present invention generally relates to retail devices, and more particularly, to a kiosk account management system and method.

### BACKGROUND

The advent of computer technology has enabled the use of many services that has been heretofore difficult to manage using traditional techniques. For example, services, such as prepaid communication services, transaction services, and the like have been enabled for widespread personal use due largely in part, to network computing systems that efficiently manage various aspects of these services, such as accounts that manage payment and use of these services as well as authorization/authentication services to ensure their proper use.

Each of these services is generally associated with an account that stores various forms of information to ensure proper usage of the service. The account is generally managed by a provider of the service. Typically for most consumer services, the account is established within a retail environment at a point-of-sale (POS) terminal, such as a cash register, manually operated by a user of the POS terminal. Nevertheless, this requirement for manual intervention during the account establishment and/or renewal process inherently creates several drawbacks in that, in many cases, creates additional costs due to various factors, such as costs associated with manual intervention and undue latency between a purchasing decision by the consumer and the time required to consummate the purchase of the service, thus hurting potential sales figures for the service. It is with these concepts in mind that embodiments of the present invention were developed.

### SUMMARY

Embodiments of the account management kiosk system and method may provide a solution to conventional retailing techniques using a graphical user interface (GUI) for managing accounts associated with consumer items administered by a service provider, such as prepaid phone services, prepaid debit cards, and loyalty card services. The GUI is controlled by a computing device that conducts one or more transactions with a service provider that provides a service associated with the consumer item and a financial account holder associated with the consumer to activate and/or renew the service associated with the consumer item in an automated manner.

According to one aspect, a kiosk account management system includes a server in communication with one or more kiosk computing devices configured in kiosks. The server receives account information from a kiosk computing device in which the account information is associated with a service provided by at least one consumer item held and displayed on the kiosk. The uses the account information to facilitate management of the account with a service provider computing device administered by a provider of the service. The server also receives, from the service provider computing device, interactive video segment information for customizing the interactive video segment, and customizing the interactive video segment according to the received interactive video segment information.

According to another aspect, a kiosk includes a housing structure to hold and display one or more consumer items, and a kiosk computing device to be housed and supported by the housing structure. The kiosk computing device generates a graphical user interface (GUI) to the display screen to receive, from the consumer, account information associated with a service provided by at least one of the consumer items, and facilitates management of the account using the account information with a service provider computing device administered by a provider of the service.

According to yet another aspect, a method includes providing a kiosk comprising a housing structure to hold and display one or more consumer items, and a kiosk computing device to be housed and supported by the housing structure and having a display screen for providing interaction with a consumer. The kiosk computing device provides the steps of receiving account information associated with a service provided by at least one of the consumer items from the consumer, and facilitating management of the account using the account information with a service provider computing device administered by a provider of the service. The method also provides the steps of receiving, from the service provider computing device, interactive video segment information for customizing the interactive video segment, and customizing the interactive video segment according to the received interactive video segment information.

### BRIEF DESCRIPTION OF THE DRAWINGS

FIG. 1 illustrates an example account management kiosk according to the teachings of the present disclosure.

FIG. 2A is a block diagram of a computing system that includes a kiosk account management system.

FIG. 2B depicts an exemplary embodiment of a computing device according to one aspect of the kiosk account management system.

FIG. 2C depicts an exemplary embodiment of a data source according to an aspect of the kiosk account management system.

FIG. 3 is a block diagram of an example kiosk management server according to an aspect of the kiosk account management system.

FIG. 4 is a flowchart depicting an example process for managing an account of a consumer item displayed on a kiosk according to an aspect of the kiosk account management system.

FIG. 5 illustrates an example of an advertising screen according to an aspect of the kiosk account management system.

FIG. 6 illustrates an example of a first or main screen display of a user interface according to an aspect of the kiosk account management system.

FIG. 7 illustrates an example of a new/existing account query screen of a user interface according to an aspect of the kiosk account management system.

FIG. 8 illustrates an example of a prepaid phone information entry request screen of a user interface according to an aspect of the kiosk account management system.

FIG. 9 illustrates an example of a debit card information entry request screen of a user interface according to an aspect of the kiosk account management system.

FIG. 10 illustrates an example of a loyalty card information entry request screen of a user interface according to an aspect of the kiosk account management system.

FIG. 11 illustrates an example of a loyalty card registration screen of a user interface according to an aspect of the kiosk account management system.

FIG. 12 illustrates an example of a loyalty card information screen of a user interface according to an aspect of the kiosk account management system.

FIG. 13 illustrates an example of a prepaid phone identification entry request screen of a user interface according to an aspect of the kiosk account management system.

FIG. 14 illustrates an example of a prepaid debit card identification entry request screen of a user interface according to an aspect of the kiosk account management system.

FIG. 15 illustrates an example of a loyalty card identification entry request screen of a user interface according to an aspect of the kiosk account management system.

FIG. 16 illustrates an example of a prepaid phone consumer input selection screen of a user interface according to an aspect of the kiosk account management system.

FIG. 17 illustrates an example of a prepaid debit card consumer input selection screen of a user interface according to an aspect of the kiosk account management system.

FIG. 18 illustrates an example of a loyalty card consumer input selection screen of a user interface according to an aspect of the kiosk account management system.

FIG. 19 illustrates an example of a payment screen of a user interface according to an aspect of the kiosk account management system.

FIG. 20 illustrates an example of a confirmation screen of a user interface according to an aspect of the kiosk account management system.

FIG. 21 illustrates an example of a prepaid phone confirmation screen of a user interface according to an aspect of the kiosk account management system.

FIG. 22 illustrates an example of a debit card confirmation screen of a user interface according to an aspect of the kiosk account management system.

FIG. 23 illustrates an example of a loyalty card confirmation screen of a user interface according to an aspect of the kiosk account management system.

FIGS. 24A through 24E illustrate another example account management kiosk according to the teachings of the present disclosure.

FIGS. 25A through 25D illustrate another example account management kiosk according to the teachings of the present disclosure.

FIGS. 26A through 26C illustrate an example retail display housing according to the teachings of the present disclosure.

FIGS. 27A through 27C illustrate an example retail display housing according to the teachings of the present disclosure.

FIG. 28 illustrates another example retail display housing according to the teachings of the present disclosure.

FIGS. 29 through 33 illustrate several example screens that may be displayed on a computing device to manage content that is played on the kiosk computing device according to the teachings of the present disclosure.

### DETAILED DESCRIPTION

As described previously, consumers enjoy many services nowadays that have been enabled by management and tracking of services in a relatively efficient manner due to the proliferation of computing technology. Nevertheless, conventional establishment of many of these services to the consumer market has relied largely on retail establishments in which manual intervention by a cashier is required to consummate the service. While it is widely known that sales of products and/or services in the consumer retail market can benefit by reducing the time between a purchase decision and consummation of that service, this conventional procedure may hinder the number of sales produced. Embodiments of the present disclosure provide a solution to this problem with a kiosk account management system that provides for establishment and/or renewal of various types of accounts for services using a kiosk that requires little or no manual intervention by retail personnel, such as a cashier. Embodiments may include an online, interactive computer driven platform, whereby a computing device configured in a kiosk may send and receive digital messages for activating and/or updating accounts used for services administered by these accounts.

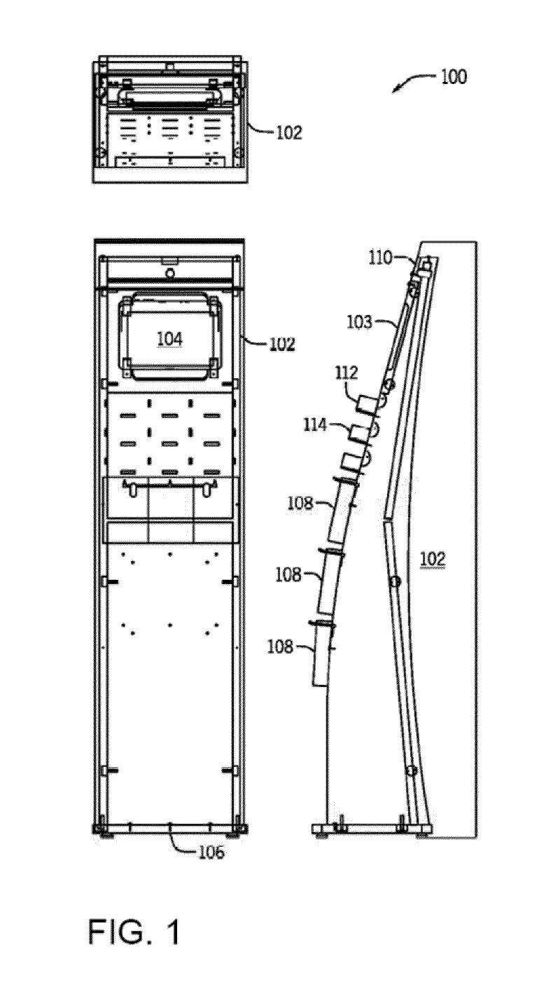

FIG. 1 illustrates an example account management kiosk 100 according to the teachings of the present disclosure. The account management kiosk 100 generally includes a housing structure, which in this particular embodiment, is a floorstand housing 102 that houses and supports a computing device 103 having a display 104. In other embodiments, the housing structure may be any type that supports the computing device 103 in a manner suitable for providing interaction with a consumer through its display 104, such as a pedestal, an adjustable support arm, or the like. Other types of housing structures will be described in detail below.

The computing device 103 generates a graphical user interface (GUI) to the display 104 for providing interaction with a consumer. The floorstand housing 102 has a bottom end 106 for support from and/or mounting to a floor, and is dimensioned such that a consumer having a standard height may access the GUI in a relatively comfortable manner. In the particular embodiment shown, for example, the floorstand housing 102 has a height of 59 and ⅞ inches, a width of 15 inches, and a depth of 12 and ⅝ inches. Nevertheless, other embodiments of the floorstand housing 102 may have other dimensions without departing from the spirit or scope of the present disclosure. For example, other embodiments of the floorstand housing 102 may have a height greater or less than 59 and ⅞ inches, a width greater or less than 15 inches, and/or a depth of greater or less than 12 and ⅝ inches.

The floorstand housing 102 may be made of any suitable material, such as wood, plastic, composites, and/or metal, that supports the computing device 103 and display 104 in a structurally sound manner. The floorstand housing 102 may also include one or more pockets 108 for housing various consumer items associated with accounts managed by the account management kiosk 100. For example, consumer items may include prepaid communication devices (e.g., prepaid mobile phones) associated with one or more providers of communication services that provide communication services used by the prepaid communication devices. As another example, the consumer items include telephone cards (e.g., calling cards, phone cards, and the like) that may be used for placing telephone calls from phones, such as land-line phones. As yet another example, the consumer items may include stored value transaction cards, such as prepaid credit cards, gift cards, and the like. As yet another example, the consumer items may include loyalty cards associated with one or more retailers, such as the retail store in which the kiosk is placed.

Each pocket 108 includes a cavity into which the consumer items may be placed, and is formed of a generally rigid material, such as sheet metal that is attached to the side of the housing 102. Nevertheless, other embodiments may include any type of housing structure for housing and displaying the consumer items or other items associated with the consumer items. The kiosk 100 also includes an optional camera 110 for surveillance purposes as will be described in detail below.

Additionally, the kiosk 100 includes monetary processing units, such as a cash processing unit 114 and/or a card reader 112. The cash processing unit 114 receives cash payment from the consumer, and dispenses monetary change for any cash amount received in excess of the required transaction fee for activating and/or renewing an account associated with the consumer items displayed on the kiosk 100. The card reader 112 includes a sensor for reading account information stored on a card in a suitable medium (e.g. magnetic strip), in a conventional manner, such as by ‘swiping’ the card through a slot configured in the card reader 112.

The particular embodiment shown merely describes one arrangement of the display 104, pockets 108, camera 110, card reader 112, and cash processing unit 114 configured on the housing 102 and that other arrangements may be provided without departing from the spirit and scope of the present invention. For example, the camera 110 may be configured at any desired position and orientation on the housing 102 for gathering images of ambient surroundings of the housing 102, such as consumers who may use the kiosk account management system 100.

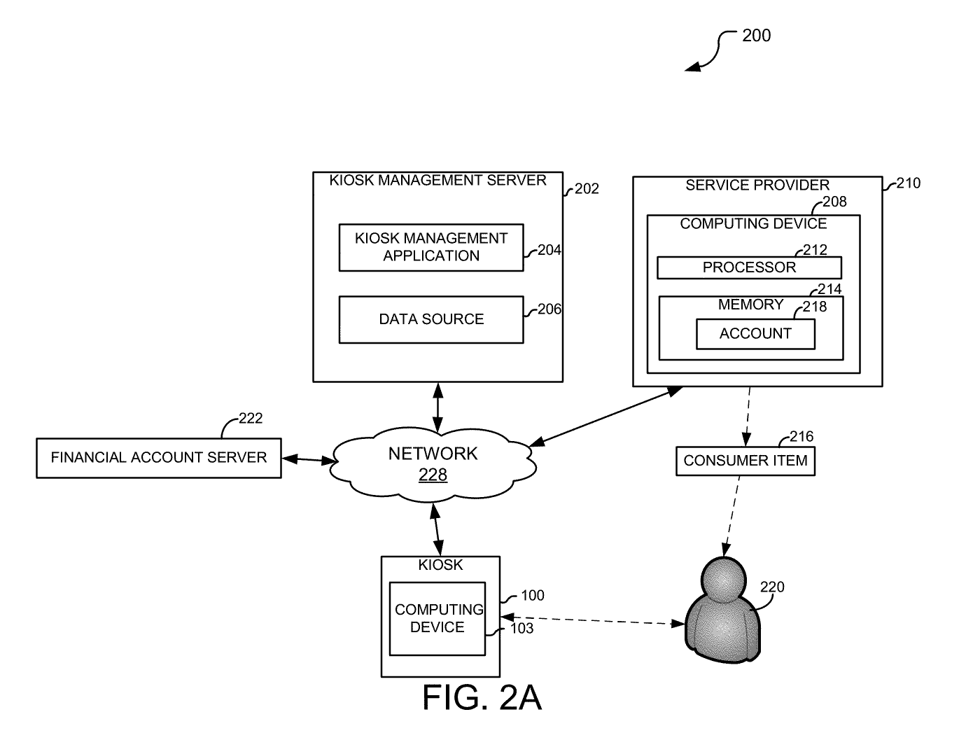

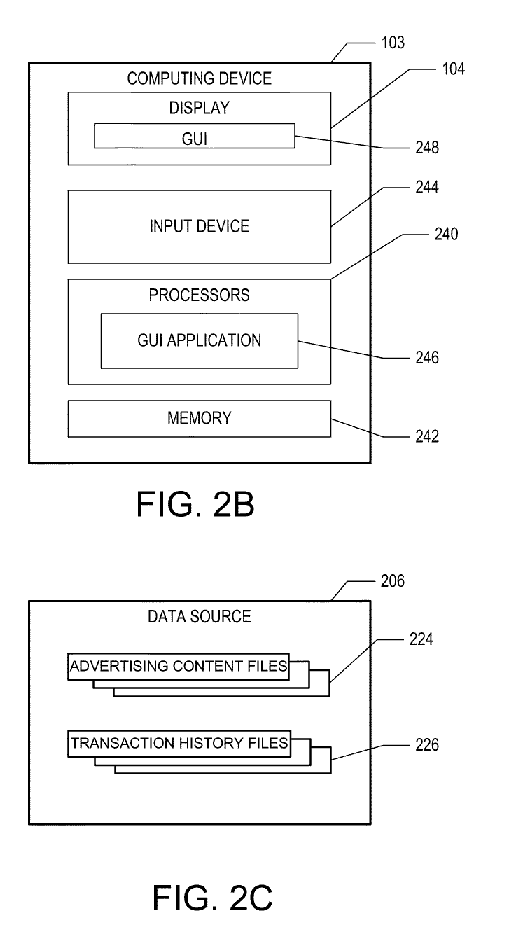

FIGS. 2A through 2C depict an example kiosk account management system 200 according to aspects of the disclosure. The system 200 includes a kiosk management server 202 or other computing device or system that includes a kiosk management application 204 and a data source 206. As will be described in detail below, the kiosk management application 204 receives account information associated with a consumer item 216, and facilitates management of an account 218 with a service provider computing device 208 administered by a provider 210 of the service.

The kiosk 100 is generally placed in any suitable location for receiving and processing account information with a consumer 220. For example, the kiosk 100 configured to process account information associated with debit cards may be placed in locations where debit cards are typically sold or managed, such as bank lobbies, or retail stores where the debit cards are typically used. As another example, a kiosk 100 configured to process account information associated with communication services, such as those provided by prepaid communication devices, may be placed in locations where communication services are serviced and/or sold, such as electronics stores, retail stores, and the like.

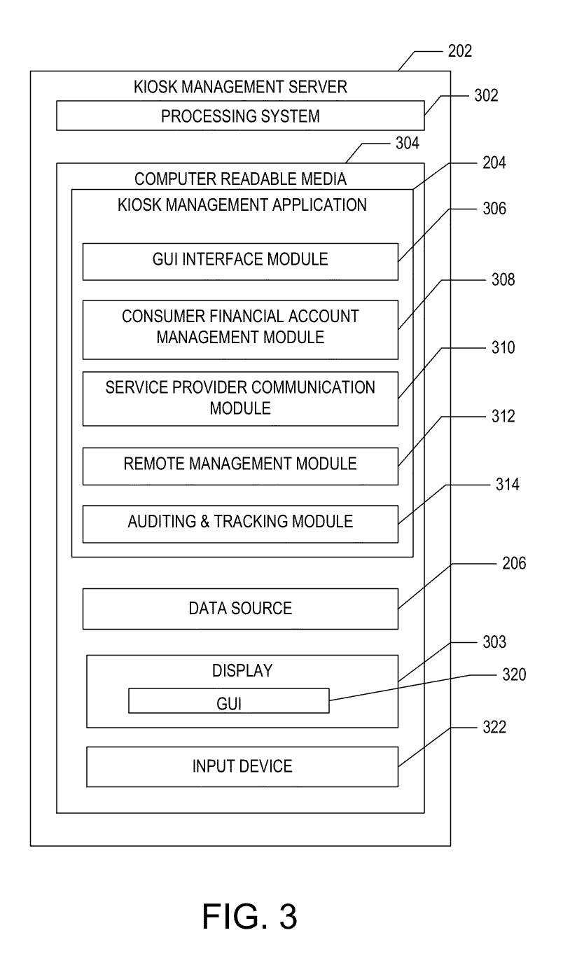

The server 202 communicates with a service provider computing device 208, or processing center of a service provider that manages the account 218 of the consumer item 216. The server 202 includes a processing system 302 (FIG. 3) that executes the kiosk management application 204 stored in volatile and/or non-volatile memory 304 (i.e., computer readable media) using the data source 206. Examples of the server 202 include one or more servers, personal computers, mobile computers and/or other mobile devices, and other computing devices. The server 202 may communicate with the service provider computing device 208 and kiosk computing device 103 via wireless and/or wireline communications. In the particular embodiments described herein below, the server 202 manages accounts 218 of consumer items 216 using the computing device 103 of the kiosk 100 in a thin client-like fashion to receive and process account information provided by the service provider computing device 208. Nevertheless, other embodiments contemplate that the computing device 103 of the kiosk 100 communicates directly with the service provider computing device 208 to process and manage account information associated with the consumer item 216.

The computing device 103 of the kiosk 100 interacts with the consumer 220 for entry of information as well as providing information associated with managing the account to the consumer 220. The kiosk account management system 100 facilitates payment processing using monetary processing units, such as a card reader 112 and/or a cash processing unit 114 for receiving payment from the consumer 220. In one embodiment, the server 202 communicates with a financial account server 222 that is associated with a financial account of the consumer to provide payment for the service by the consumer 220. The server 202 may also communicate with the computing device 103 to receive cash payment via the cash processing unit 114. The financial account may be any type, such as a credit card account, a debit card account, or a PAYPALTM account. Prior to activation, renewal, or otherwise management of the service, the server 202 facilitates a financial transaction between the service provider computing device 208 and the financial account server 222 associated with the consumer to provide payment for the service. The financial account server 222 has one or more processors and executable instructions stored in volatile and/or non-volatile memory for performing the actions and/or steps described herein.

The service provider computing device 208 has one or more processors 212 and volatile and/or non-volatile memory 214. Examples of the service provider computing device 208 include one or more personal computers, mobile computers and/or other mobile devices, and other computing devices. The service provider computing device 208 may communicate via wireless and/or wireline communications.

The data source 206 stores advertising content 224 and transaction history files 226 that include transaction information associated with each transaction conducted via the system 200. Although the data source 206 is shown as being located on, at, or within the local server 202, it is contemplated that the data source 206 can be located remotely from the local server 202 in other aspects of the system 200, such as on, at, or within a database of a data management system or a database of another computing device or system having at least one processor and volatile and/or non-volatile memory. In one embodiment, the data source 206 comprises a relational database management system, such as a MySQL-based database structure that provides a front end for entry and access of data stored therein and provides for replication for increased reliability and/or mirroring by other sites that use the account management kiosk 100.

The communication network 228 can be the Internet, an intranet, or another wired and/or wireless communication network. In one aspect, one or more of the server 202 and the computing device 103 communicate with one another using any suitable protocol or messaging scheme. For example, the server 202 and computing device 103 may communicate using a Hypertext Transfer Protocol (HTTP), extensible markup language (XML), extensible hypertext markup language (XHTML), or a Wireless Application Protocol (WAP) protocol. Other examples of communication protocols exist. Although the example of FIG. 2A shows the server 202 communicating with the computing device 103 through a network, other embodiments contemplate the server 202 communicating directly with the computing device 103 without the use of a separate and a distinct network. Additionally, other embodiments contemplate that the modules employed by the server 202 and the computing device 103 are integrated in one computing system.

FIG. 2B depicts an example embodiment of a kiosk computing device 103 according to one aspect of the kiosk account management system 200. The computing device 103 is a computing or processing device that includes one or more processors 240 and memory 242 and is to receive data and/or communications from, and/or transmit data and/or communications to, the server 202 via the communication network 228. The computing device 103 includes a display 104, such as a computer monitor, for displaying data and/or a graphical user interface 248. The computing device 103 may also include an input device 244, such as a keyboard or a pointing device (e.g., a mouse, trackball, pen, or touch screen) to enter data into or interact with the graphical user interface 248. In one embodiment, the display 104 comprises a touchscreen device in which input is provided via contact by the consumer with the touchscreen device.

The computing device 103 may also include a graphical user interface (or GUI) application 246, such as a browser application, or application software (i.e., a mobile app) stored in the memory 242 and executed on the processors 240 to generate a graphical user interface 248 to the display 104. The graphical user interface 242 enables the computing device 103 of the consumer to interact with one or more data entry forms received from the server 202 to enter detail data for the purpose of managing an account of the consumer 220.

In one embodiment, the computing device 103 is a commercial off-the-shelf (COTS) computing device, such as a personal computer, a mobile computer, a tablet computer, a mobile device, and/or other computing device that is configured in or on the housing 102 using one or more mounting mechanisms, such as screws, bolts, hooks, zip ties, adhesives, track system, or other mechanism, such as one that maintains the computing device in or on the housing 102 using a tensioning mechanism. Such as COTS device includes a charging tether for providing power to the computing device, and/or a security or lasso tether to prevent its theft.

In another embodiment, the computing device 103 includes a custom design with the display 104, audio generation device 246, processors 240, and memory 242 individually integrated into the housing 102. For example, the display 104 and audio generation device 246 may be mounted on a surface of the housing 102 using a suitable attachment mechanism for providing advertising content to consumers. Example of such attachment mechanisms include, for example hinges and/or adhesives, such as weldment, hot glue, epoxy, and the like. Another example includes a housing 102 made of plastic that includes tabs integrally formed on the housing that hold the display 104 and audio generation device 246 in or on the housing 102 using a press-type fit. Yet another example includes tabs integrally formed on the housing 102 that are bent by the application of heat to secure the display 104, audio generation device 246, processors 240, and/or memory 242 to the housing 102.

In a particular embodiment, the computing device 103 is a tablet computer and the application 248 is embodied as application software (i.e., an app) designed to be executed on the computing device 103. The operating software may be configured as a permissions-based format such that only the app is allowed to execute for administering the kiosk account management system 200. That is, consumers may be inhibited from executing any other application on the computing device 103. Additionally, the app may be locked (i.e., inhibited from executing) in response to detection of a tampering event and/or due to malfunction of the system. The server 102 may also include administrator privileges (e.g. super user mode) that can be accessed via a unique key combination (e.g., password access) for servicing, maintaining, or otherwise administering the operation of the computing device 103. The tablet computer may be configured on the housing 102 such that its display is oriented in either a landscape mode or a portrait mode.

FIG. 3 is a block diagram depicting an example kiosk management application 204 executing on the kiosk management server 202. According to one aspect, the kiosk management server 202 includes a processing system 302 that includes one or more processors or other processing devices. A processor is hardware. The processing system 302 executes the kiosk management application 204 to generate a GUI on a display of the computing device 103 in order to receive account information from a consumer and manage an account associated with one or more consumer items displayed on the kiosk. According to another aspect, the kiosk management server 202 also includes a display 303, such as a computer monitor, for displaying data and/or a graphical user interface 320. The kiosk management server 202 may also include an input device 322, such as a keyboard or a pointing device (e.g., a mouse, trackball, pen, or touch screen) to enter data into or interact with the graphical user interface 322.

According to one aspect, the kiosk management server 202 includes a computer readable media 304 on which the kiosk management application 204 and data source 106 are stored. The kiosk management application 204 includes instructions or modules that are executable by the processing system 302 to manage an account owned by the consumer 220.

The computer readable media 304 may include volatile media, nonvolatile media, removable media, non-removable media, and/or another available media that can be accessed by the kiosk management server 202. By way of example and not limitation, computer readable media 304 comprises computer storage media and communication media. Computer storage media includes non-transient storage memory/media, volatile media, nonvolatile media, removable media, and/or non-removable media implemented in a method or technology for storage of information, such as computer/machine readable/executable instructions, data structures, program modules, and/or other data. Communication media may embody computer readable instructions, data structures, program modules, or other data and include an information delivery media or system.

A GUI interface module 306 facilitates the receipt of data and/or other communications from the computing device 103 of the kiosk 102. In one example, the computing device 103 executes a graphical user interface (GUI) that displays an interactive display, or other suitable user interface mechanism including one or more selectable fields, editing screens, and the like for receiving instructions and data and activating the card by the consumer.

A consumer financial account management module 308 communicates with a payment processing server, such as the financial account server 222, to transact a monetary transfer of funds from the consumer's financial account to a financial account of the service provider 210. For example, the consumer financial account management module 308 receives credit card information from the card reader 112 and transmits this information to the financial account server 222 associated with the consumer to facilitate payment for the service provided by the consumer item 216.

A service provider communication module 310 communicates with the service provider computing device 208 for managing the account. For example, the service provider computing module 310 receives instructions from the service provider computing device 208 for receiving certain elements of information from the consumer, and generates GUI on the kiosk computing device 103 for obtaining the desired information from the consumer. As another example, the service provider computing module 310 communicates with the service provider computing device 208 to coordinate payment for the service, such as by coordinating payment information between the consumer financial account management module 308 and the service provider computing device 208 for payment processing using a credit card of the consumer, or alternatively, with the cash processing unit 114 for payment processing using each payment provided by the consumer.

A remote management module 312 communicates with the computing device 103 of the kiosk 100 to manage various functions associated with its operation. For example, the remote management module 312 may communicate with the computing device 103 to ensure its proper operation, and disable the computing device 103 from further operation if a failure or malfunction is detected. In one embodiment, the remote management module 312 may erase the memory of the computing device 103 if a fraudulent event is detected. Also, the remote management module 312 may provide for remote access to the computing device 103 from the kiosk management server 202. The remote management module 312 may also communicate with the computing device 103 to administer software updates to the computing device 103.

In one embodiment, the remote management module 312 may communicate with one or more sensors of the kiosk 100 for surveillance and/or fraud detection purposes. For example, the remote management module 312 may receive images and/or video information from a camera of the kiosk 100. During one of the account management procedures described herein, the camera may take an image of the consumer at periodic intervals (e.g., 5 second intervals) and/or at events, such during consumer input or selection of certain fields, and the computing device 103 stores the images for future reference in the event that a fraudulent event is detected at a later time. Alternatively, the computing device 103 transmits the images to a kiosk management server 202 for storage in the data source 206.

In another embodiment, the remote management module 312 generates a GUI 320 that displays various activities and provides for administrative control of one or more computing devices 103 of the kiosk 100 from the kiosk management server 202. For example, the GUI 320 may be generated in the form of a dashboard in which multiple characteristics of each of multiple computing devices 103 may be monitored and controlled. The GUI 320 is generated on the display 303 of the server 202 and various fields of the GUI 320 controlled via the input device 322 of the server 202.

The GUI 320 may display various characteristics of each computing device 103, such as an index to any transaction history files 226 associated with the operation of its respective computing device 103. For example, the transaction history files 226 may include sales data, location data obtained via a location detection device (e.g., global positioning system (GPS) device) of the computing device 103, device health, a history of fraudulent alerts, and any images/video obtained via the camera of the kiosk 100.

Additionally, the GUI 320 may receive input via the input device 322 to control the operation of the computing device 103. For example, an administrator may, from the display 303 and input device 322 of the server 202, control the computing device 103 to inhibit or allow certain functionality, perform periodic maintenance on the computing device 103, and/or access one or more log files associated with the operation of the computing device 103.

In one embodiment, the remote management module 312 may facilitate the management of multi-media content that is played on the kiosk computing device 103. The multi-media content may include any suitable type, such as advertising content that is played on the kiosk computing device 103 during periods when consumers are not actively managing their accounts, or other content that may include special offers to certain consumers as they are actively managing one or more of their accounts.

The remote management module 312 may be configured to facilitate management of content of one or more kiosk computing devices 103 that is dedicated to a particular service provider 210, or may be adapted to facilitate management of content for kiosk computing devices 103 used by multiple service providers 210. In a first case in which the kiosk management server 202 is owned and managed by the service provider 210, the service provider 210 may use the GUI 320 and input device 322 to modify various aspects of the multi-media content, such as what content are played, how long and at what time the content is played, a sequence or order in which multiple instances of the content is played, and the like.

In a second case in which the kiosk computing devices 103 are used by multiple service providers 210, the remote management module 312 may communicate, via the service provider communication module 310, with the service provider computing devices 208 of each service provider 210 to transmit/receive content management information to/from a GUI and input device configured on the service provider computing device 208. For example, the remote management module 312 may communicate with a GUI application, such as a browser application, or application software (e.g., a mobile app) stored in the memory 214 and executed on the processor 212 to generate the GUI on a display of the service provider computing device 208. The GUI enables the computing device 208 of the service provider to interact with one or more data entry forms received from the remote management module 312 to receive content management information and enter data associated with the content.

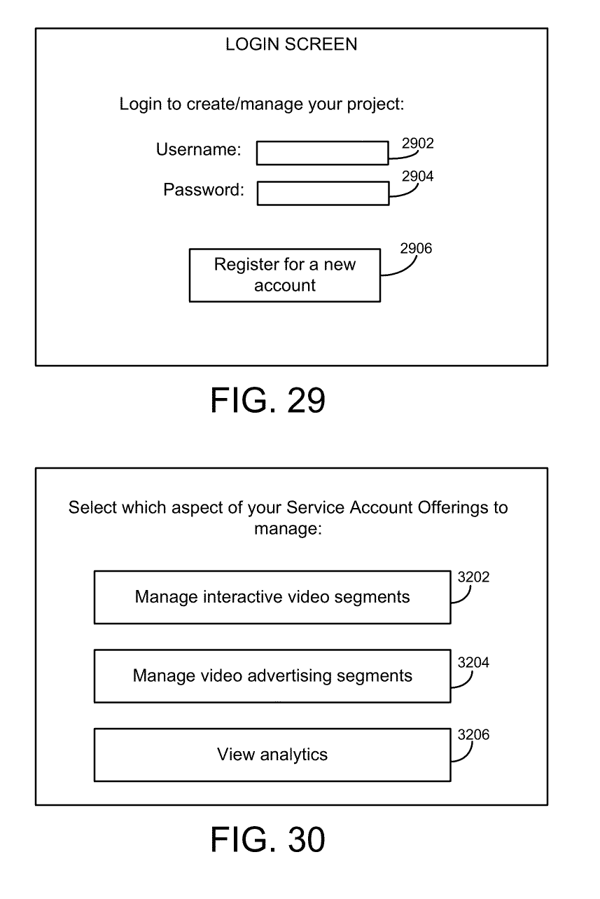

In a particular example, the remote management module 312 may generate a login screen (FIG. 29) that is used to receive passcode information from the service provider 210 for establishing a login session with the service provider 210. The login screen includes a username field 2902 and a password field 2904 for entry of a username and password, respectively, for an account associated with a service provider 210. The login session provides for authentication of the service provider 210 to mitigate the possibility of any illicit use of the account of the service provider. Although a username/password combination is described herein for establishing a login session, it should be understood that the service provider login screen may use any suitable authentication mechanism. For example, the service provider login screen may communicate with the service provider computing device 208 to receive biometric scan data, such as fingerprint data obtained from a fingerprint scan device to authenticate the user for establishing the login session. The service provider login screen may also include a registration button 2906 that when selected, causes the remote management module 312 to generate one or more other screens for registering an account with the service provider 210.

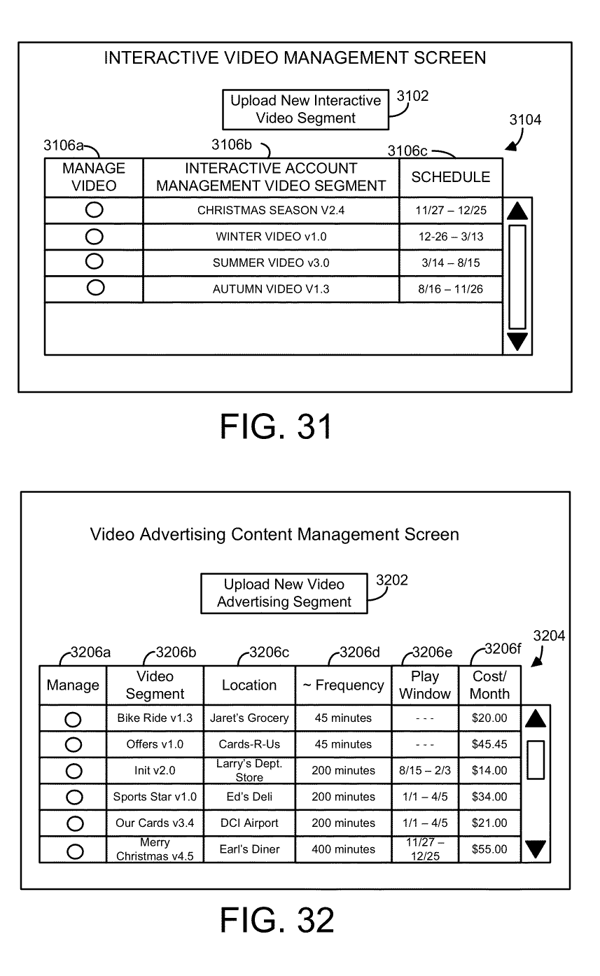

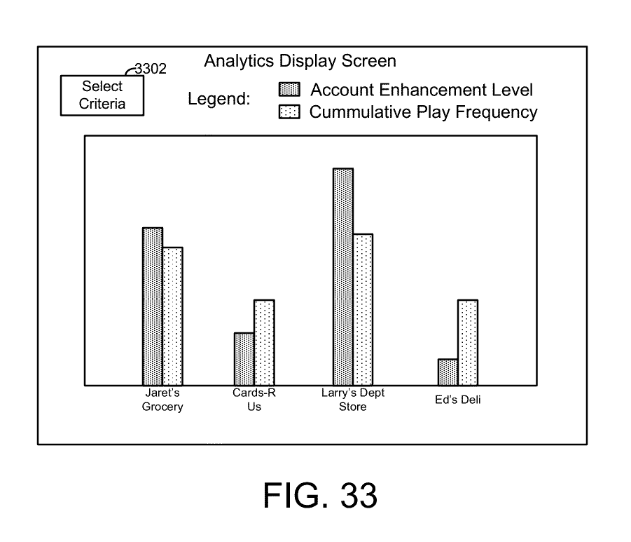

Once the service provider 116 has been authenticated, a splash screen (FIG. 30) may be displayed that provides a mechanism for selection of various management screens. The splash screen displays a ‘manage interactive video segment’ button 3002, a ‘manage video advertising content’ button 3004, and a ‘view analytics’ button 3006 that directs the remote management module 312 to display an interactive video management screen (FIG. 31), a video advertising content management screen (FIG. 32), and an analytics display screen (FIG. 33), respectively. For example, if a service provider 210 wishes to manage video advertising content played on the kiosk computing device 103, he or she would select the ‘manage video advertising content’ button 3004 to have the video advertising content management screen displayed on the computing device 208.

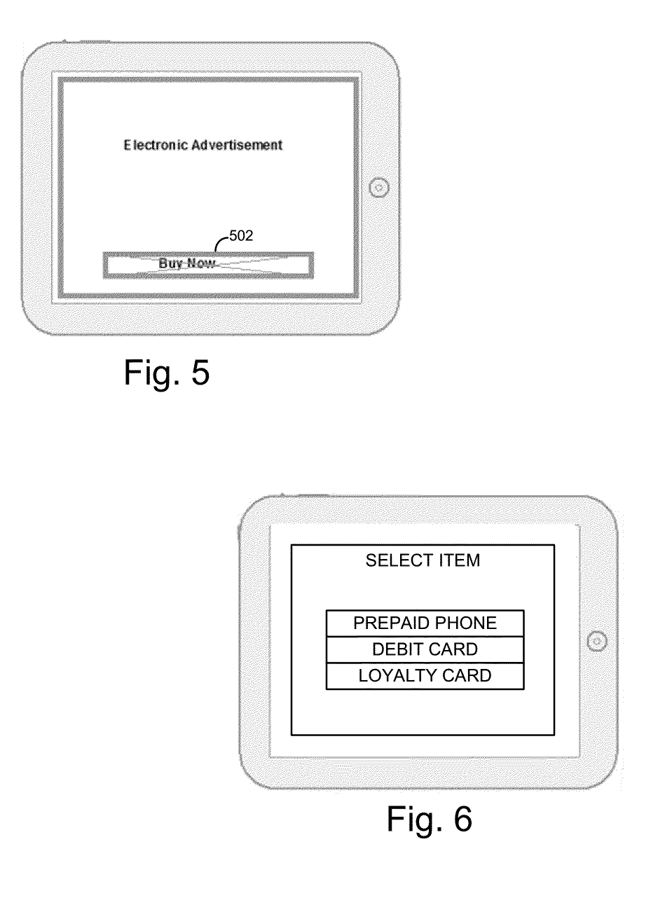

As shown in FIG. 31, the interactive video management screen includes an ‘upload new interactive video segment’ button 3102 and a table 3104 that displays a list of the interactive video segments that have been previously uploaded by the remote management module 312, such as may have been performed during a previous login session. Each interactive video segment generally includes content for displaying interactive video content for interacting with a consumer, such as that described in FIGS. 5 through 23 herein below. Nevertheless, each interactive video segment may differ from one another for various reasons, such as due to changes in design (e.g., background imagery, music played during the interactive session, etc.), the addition and/or deletion of special incentive offers that may be occasionally offered to the consumers, seasonal changes during the year (e.g., Christmas, Easter, etc.), and demographic changes (e.g., Kansas City versus Atlanta locations). Thus, each interactive video segment may be customized by the service provider according to specific marketing promotions developed for their products/services.

Embodiments of the present disclosure may provide certain advantages not heretofore recognized by conventional interactive kiosks. For example, whereas conventional interactive kiosks are mostly static in that they do not provide the ability to customize and/or modify the content (e.g., signage), the interactive video management screen provides for dynamic modification of content to adjust for ongoing changes in demographics, seasonal changes, and/or changes in market conditions. Additionally, the interactive video segments may be modified remotely such that personnel may be alleviated from having to travel to the location of each kiosk 100 for modifying the interactive video content displayed on each kiosk 100.

The table 3104 is arranged in rows and columns in which each row is associated with one interactive video segment, while each column displays various information about its respective interactive video segment. For example, the rows may include a ‘manage video’ column 3106a, an ‘interactive video segment name’ column 3106b, and a ‘schedule’ column 3106c. The ‘interactive video segment name’ column 3106b displays a name of its respective interactive video segment. The ‘schedule’ column 3106c displays information about when its respective interactive video segment is to be played, such as when a consumer interacts with the system for updating their account.

Schedule information included in the ‘schedule’ column 3106c indicates a date and/or time that its associated interactive video segment is to be played. For example, as shown, four interactive video segments are shown that are scheduled to be played over differing times of the year. That is, when a consumer interacts with the system to update their account, the interactive video segment scheduled at the date or time specified in the ‘schedule’ column 3106c will be the one that is played. Other types of schedules may be used. For example, the schedules may include differing times of the day, such as a first interactive video segment that is to be played during morning hours, while a second interactive video segment is to be played during the afternoon hours. As another example, the schedules may include a specified marketing promotion campaign that is to last for a specified period in time, in which a first interactive video segment is scheduled to last for six weeks, while a second interactive video segment is to be played thereafter.

When a cell in the ‘manage video’ column 3106a is selected, the remote management module 312 may display one or more other screens for managing the interactive video segment associated with the selected cell. Examples of management operations may include deletion of the interactive video segment, customization of the interactive video segment, and/or modification of the schedule to of the interactive video segment. The ‘upload new interactive video segment’ button 3102 is provided to upload a new interactive video segment to the system.

When the service provider 210 selects the ‘manage advertising content’ button 2904, the remote management module 312 may then display a video advertising content management screen as shown in FIG. 32. The video advertising content management screen generally includes an ‘upload new video advertising segment’ button 3202 and a table 3204 that displays a list of the video advertising segments that have been previously uploaded by the remote management module 312. Each video advertising segment generally includes content for displaying advertisements on the kiosk computing device 103, such as when no interactive video segments are currently interacting with a consumer. One particular example of advertising content includes that described in U.S. patent application Ser. No. 13/946,749, entitled “Stored Value Card Display Advertising System and Method”, and filed on Jul. 19, 2014, the contents of which are incorporated by reference in its entirety.

The table 3204 is arranged in rows and columns in which each row is associated with one video advertising segment, while each column displays various information about its respective video advertising segment. For example, the rows may include a ‘manage’ column 3206a, a ‘video segment name’ column 3206b, a ‘location’ column 3206c, a ‘frequency’ column 3206d, a ‘play window’ column 3206e, and a ‘cost-per-month’ column 3206f. The ‘video segment name’ column 3206b displays a name of its respective video advertising segment. The ‘location’ column 3206c indicates the general location in which the kiosk 100 is placed. For example, the ‘bike ride version 1.3’ video advertising segment is to be played on a kiosk 100 placed within a commercial building identified as Jaret's Grocery store.

The ‘frequency’ column 3206d indicates an approximate frequency that the subject video advertising segment is to be played on the kiosk computing device 103 and is a selectable value that may be selected by the service provider 210 when the video segment is edited by selection of the cell associated with that video advertising segment in the ‘manage’ column 3206a. Additionally, the ‘play window’ column 3206e indicates a beginning and an ending time frame that the video advertising segment is to be played. For example, the ‘merry Christmas’ video advertising segment as shown in FIG. 32 is to be played during the yuletide season beginning on November 27th and ending on December 25th. Like the ‘frequency’ column 3206d, its values are editable by the service provider by when the video segment is edited by selection of the cell associated with that video advertising segment in the ‘manage’ column 3206a. The remote management module 312 may use these user selected values to generate an ongoing playlist of multiple video advertising segments that at least approximates the desired frequency and play window specified by one or more service providers. Moreover, the multiple video advertising segments may include only those of one service provider, or may be a combined set of video advertising segments provided from multiple service providers.

The ‘cost-per-month’ column 3206f indicates a cost per month assessed to the service provider for playing the associated video advertising segment on the kiosk computing device 103. The cost-per-month's value is generated by the remote management module 312 and may be generally increase as the video advertising segments are played more regularly (e.g., reduced frequency values selected by the service provider) and reduced as the video advertising segments are played less regularly. Additionally, the cost-per-month's value may increase to account for play during peak traffic days and/or hours (e.g., Christmas shopping season, working hours, etc.) and reduced during other days and/or hours that are off-peak times.

When a cell in the ‘manage’ column 3206a is selected, the remote management module 312 may display one or more other screens for managing the video advertising segment associated with the selected cell. Examples of management operations may include deletion of the video advertising segment, customization of the video advertising segment, and/or modification of the frequency, and/or play window of the video advertising segment. The ‘upload new video advertising segment’ button 3202 is provided to upload a new video advertising segment to the system.

When the service provider selects the ‘view analytics’ button 2906 as shown in FIG. 30, the remote management module 312 may then display a analytics display screen as shown in FIG. 33. The analytics display screen generally displays information associated with sales (e.g., enhancements to the account of consumers) with respect to various aspects of each kiosk 100 that may have an effect upon those sales. The service provider may view this information to make decisions about any modifications to be made to any interactive video segments and/or video advertising segments played on the kiosk computing devices 103.

As shown in FIG. 33 for example, measured account enhancement levels (e.g., sales) are shown against a cumulative playing frequency for several kiosks 100 in the system. The cumulative playing frequency generally refers to a combined amount of time that any video advertising segments associated with that service provider are played on each kiosk computing device 103. Nevertheless, it should be understood that any type of measured value may be displayed by the analytics display screen for analyzing the effectiveness of video advertising segments and/or interactive video segments of each kiosk 100. Other types of measured values may include, for example, sales values with respect to a time of day that the video advertising segments are played, sales values with respect to seasonal patterns, sales values with respect to each video advertising segment that is played, sales values with respect to each interactive video segment that is played. Other measured values not listed herein may be used. Selection of which type of measured values to be displayed may be provided by a ‘select criteria’ button 3302 included in the analytics display screen.

The measured values may be obtained from any suitable source. For example, the remote management module 312 may obtain the measured values by monitoring account management information transferred through either of the consumer financial account management module 308 and/or the service provider communication module 310. As another example, the measured values may be obtained from each kiosk computing device 103 that monitors account management activities that are processed thereon.

In one embodiment, the remote management module 312 may perform one or more monitoring functions on each kiosk computing device 103 to ensure its proper operation. For example, the remote management module 312 may periodically obtain location information from the kiosk computing device 103 that indicates its location, and perform one or more actions based upon the obtained location information. In one case, the remote management module 312 may establish a boundary, such as a specified radial distance (e.g., 50 feet) away from an original location from the kiosk computing device 103 and perform some corrective action (e.g., disable the device, erase the memory of the kiosk computing device, generate an alert message, etc.) if the kiosk computing device 103 travels beyond the established boundary.

In another embodiment, the remote management module 312 may periodically monitor a communication connection between the kiosk computing device and the kiosk management server 202 and perform one or more corrective actions (e.g., generate an alert message) if the connection is lost.

An auditing and tracking module 314 maintains a historical record of transactions conducted through the use of the kiosk 100 by storing the transactions in the activation history files 230. For example, the auditing and tracking module 314 may periodically report (or report upon demand) usage information associated with the kiosk 100. This usage information may include, for example, which type of accounts are most often managed and/or otherwise activated, and a distribution of how much money is transacted with these accounts. Information such as this may be useful for distribution to merchants that offer stored value cards to solicit their further use of the account management kiosk 100.

It should be appreciated that the modules described herein are provided only as an example of a computing device that may execute the kiosk management application 204 according to the teachings of the present invention, and that other computing devices may have the same modules, different modules, additional modules, or fewer modules than those described herein. For example, one or more modules as described in FIG. 3 may be combined into a single module. As another example, certain modules described herein may be encoded and executed on other computing devices, such as the computing device 103 used by the consumer. Further, one or more or all of the modules may be stored and executed by the kiosk management server 202 and data and instructions are transmitted to and from the kiosk management server 202 and the computing device 103 to execute their functions.

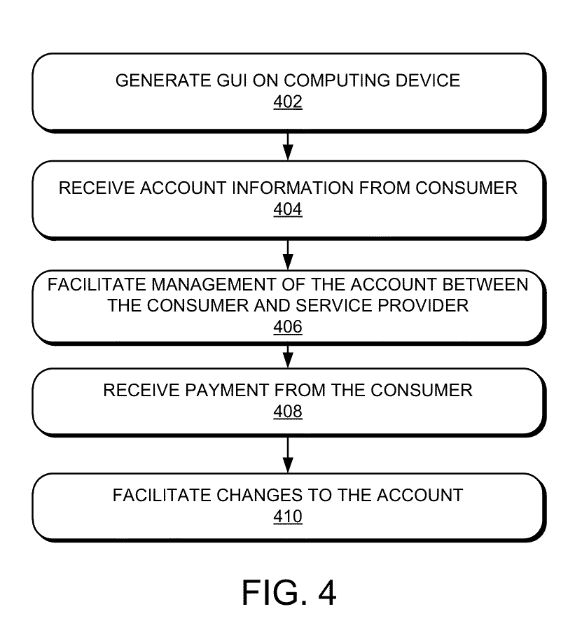

FIG. 4 illustrates an example process that may be performed by the kiosk management application 204 according to the teachings of the present disclosure.

In step 402, a GUI is generated to the display of the computing device 103 of the kiosk 100. The computing device 103 may function as a thin client such that the kiosk management application 204 administers the generation of the GUI on the computing device 103. In another embodiment, the computing device 103 includes instructions in its memory for generating the GUI on its display, such as by application software (i.e., an app) designed to be executed on the computing device 103 embodied as a tablet computer or other similar type of portable computing device. In another example, the GUI module is on the kiosk management server 202, and the kiosk management server generates the GUI screens to the display of the computing device 103.

According to one aspect, the application 204 generates an advertising screen (FIG. 5) for displaying advertising content for view by consumers. The advertising content includes any type of information, such as information for marketing the consumer items whose accounts are processed by the system 200. In one embodiment, the advertising content may be stored in one or more advertising content files 224 in the server 202. The marketing content may be presented in any suitable form, such as a video segment, an animation, a text message, audio message, or any combination thereof. For example, the advertising screen generates multiple short (e.g., 30 second) video segments that are sequentially displayed on the display 104 of the computing device 103 in which each segment is tailored to enhance a perceived appeal of the services provided by the consumer items.

As another example, marketing content (e.g., advertisements, special offers, etc.) may be displayed on any of the screens described herein for view by the consumer. The marketing content may be displayed while performing the process, or while the computing device 103 is idly waiting to be used by the next consumer. The marketing content may be pushed to the computing device 103 from the kiosk management server 202 on an on-demand type basis. For example, the administrator of the kiosk management server 202 may selectively push marketing content to be displayed based upon previously agreed upon contracts between the service provider 210 and the administrators of the kiosk account management system 200. The marketing content may be presented in any suitable form, such as a video segment, an animation, a text message, audio message, or any combination thereof. Additional details related to generating advertising content to be displayed on the computing device are described in U.S. patent application Ser. No. 13/946,749, filed Jul. 19, 2013, and entitled “Stored Value Card Display Advertising System and Method,” which is hereby incorporated herein by reference in its entirety.

The advertising screen (FIG. 5) includes a “Buy Now” button 502 that when selected by a consumer, causes the application 204 to generate a main screen display (FIG. 6) showing elements such as text and graphics describing and explaining use of the system. Typically, the main screen display also includes text and graphics comprising primary navigation elements, such as one or more consumer items whose accounts may be managed using the system 200. The particular main screen display shows a “Prepaid Phone” button, a “Debit Card” button, and a “Loyalty Card” button that may each be selected to activate a new account or manage an existing account associated with each of a prepaid communication service, a debit card service, and a loyalty card service, respectively. Although the main screen display as shown provides for management of a prepaid communication service, a debit card service, and a loyalty card service, it should be understood that other account types not described herein may also be managed using the system 200. Additionally, the main screen display may provide for management of any number of account types using the system 200. For example, the main screen display may only provide for management of prepaid communication services, or alternatively, only for management of a loyalty card service such that the main screen display (FIG. 6) is not needed.

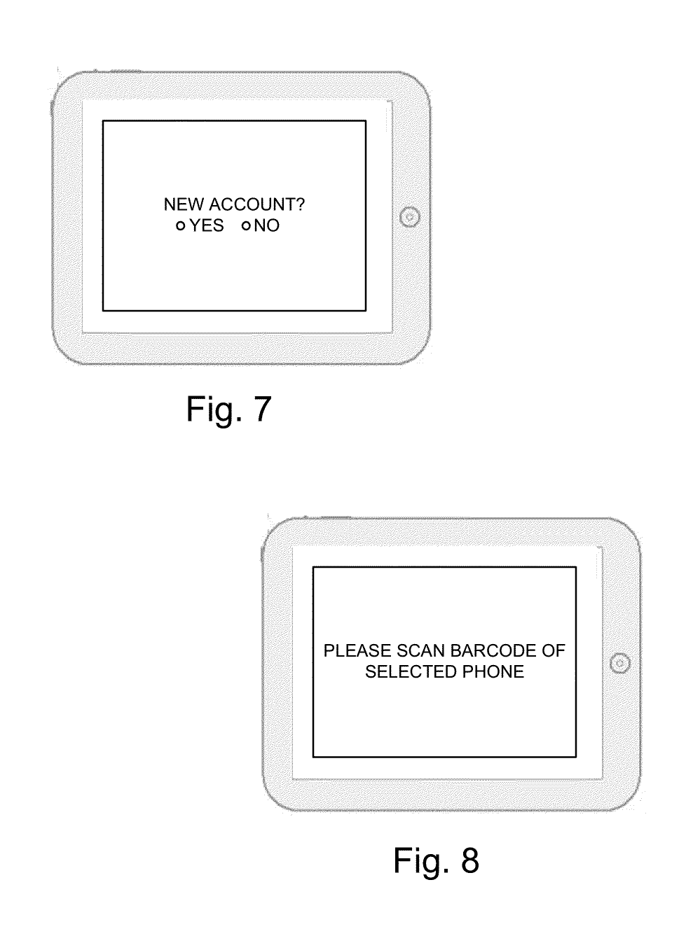

In step 404, the kiosk management application 204 receives account information associated with the consumer item from the consumer. The kiosk management application 204 may receive account information for an existing account, or may receive information for the creation of a new account to be associated with the consumer item. For example, the application 204 may generate a new/existing account query screen (FIG. 7) to receive information whether the account to be managed is a new or an existing account.

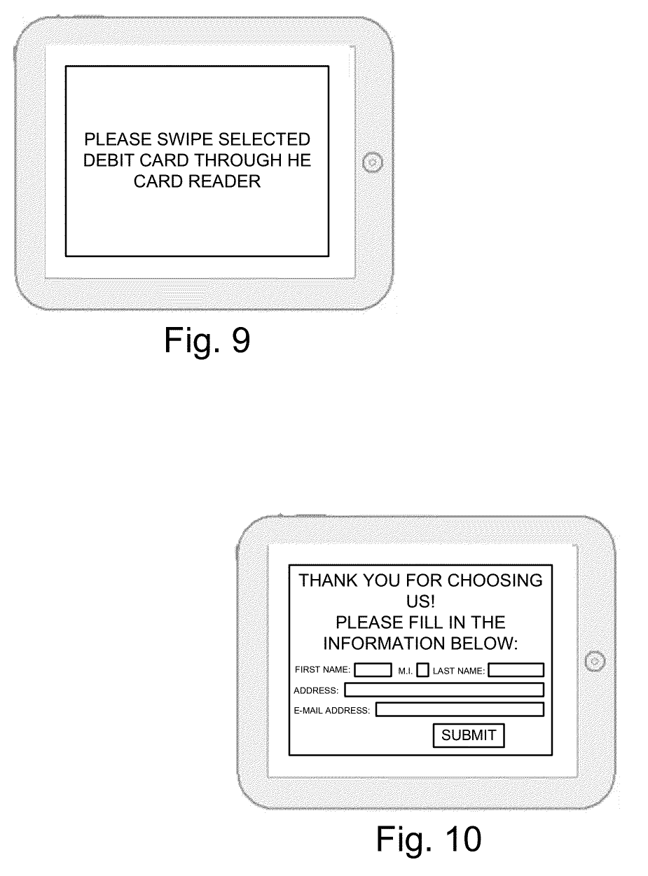

If a new account is selected, the application 204 generates one or more screens for retrieving information for managing or otherwise modifying and/or updating the account associated with the consumer item. For example, if the consumer has selected management of a new, yet to be activated, prepaid communication service, the application 204 generates a prepaid phone information entry request screen (FIG. 8) that instructs the consumer to enter identification information associated with the consumer item (e.g., prepaid phone), which in this particular example is a barcode including serial number information of the prepaid phone imprinted on a retail packaging of the prepaid phone. As another example, if the consumer has selected management of a new, yet to be activated, prepaid debit card, the application 204 generates a debit card information entry request screen (FIG. 9) that instructs the consumer to enter identification information associated with the debit card, which in this particular example is provided on a magnetic strip of the unactivated debit card.

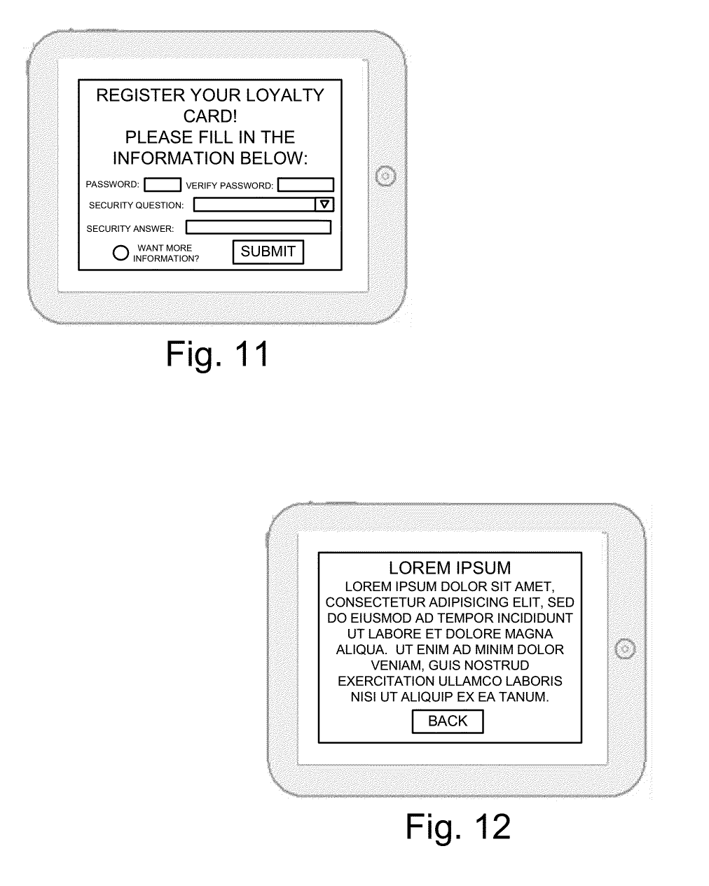

As yet another example, if the consumer has selected management of a new, yet to be activated, loyalty card, the application 204 generates a loyalty card information entry request screen (FIG. 10) that instructs the consumer to enter one or more elements of personal information to be associated with the loyalty card, such as the name of the user to whom the loyalty card will be issued to, a physical mailing address of the user, and an e-mail address of the user. The loyalty card information entry request screen includes a ‘submit’ button that causes the application 204 to generate a loyalty card registration screen (FIG. 11). The loyalty card registration screen provides for entry of other information to be associated with the loyalty card account, such as a user-defined password, and one or more security questions to be used if the user forgets the user-defined password or for general enhancement of security for the account. The loyalty card information entry request screen may include a selection button that, when selected by the user, causes the application 204 to generate a loyalty card information screen (FIG. 12). The loyalty card information screen may display any type of information related to the newly registered loyalty card, such as any terms or conditions under which the loyalty card may be used, any further actions to be taken to consummate the registration process, and/or licensing terms to be applied to the usage of the newly registered loyalty card.

It should be understood that the information elements provided in the loyalty card information request screen and the loyalty card registration screen merely show example various types of information that may be received from the user for registering a loyalty card and that other types of information may be received without departing from the spirit or scope of the disclosure. For example, the loyalty card information request screen and the loyalty card registration screen may be configured to receive information, such as an age of the consumer, one or more phone numbers of the consumer, work address of the consumer, and the like. Additionally, although two screens (e.g., the loyalty card information request screen and the loyalty card registration screen) are implemented for entry of personal information from the user, only one screen or more than two screens may be used for entry of personal information from the user.

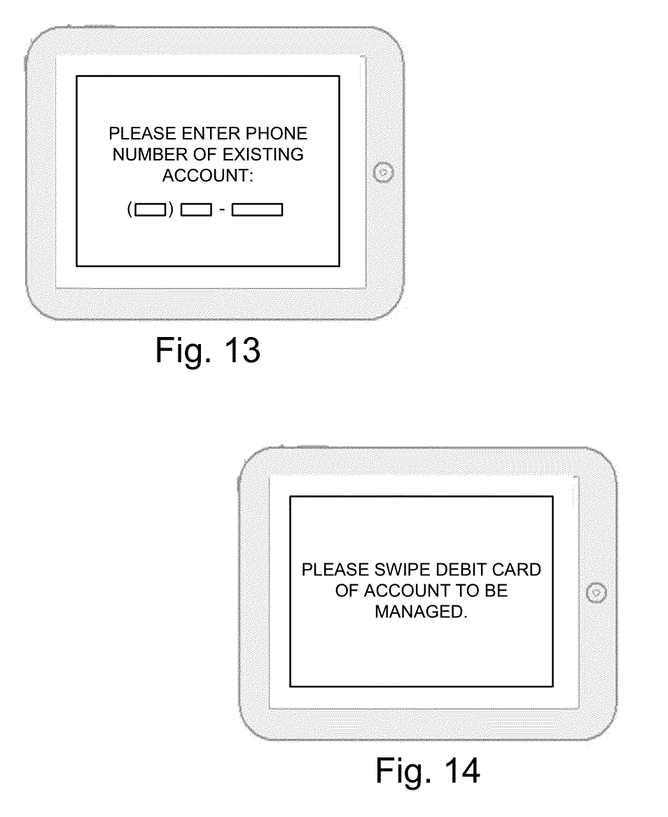

If on the other hand, the consumer has selected management of an existing service, the application 204 generates one or more screens for retrieving information for managing or otherwise modifying and/or updating the account associated with the consumer item. For example, if the consumer has selected management of an existing prepaid communication service, the application 204 generates a prepaid phone identification entry request screen (FIG. 13) instructing the consumer to enter identification information associated with the prepaid phone that has already been established with an account. For example, the identification information shown includes a phone number to be associated with the account. Nevertheless, the application 204 may use any suitable form of identification for uniquely identifying the prepaid phone account to be managed by the application 204. For example, the application 204 may request input of a serial number associated with the phone to uniquely identify the service to be managed by the application 204.

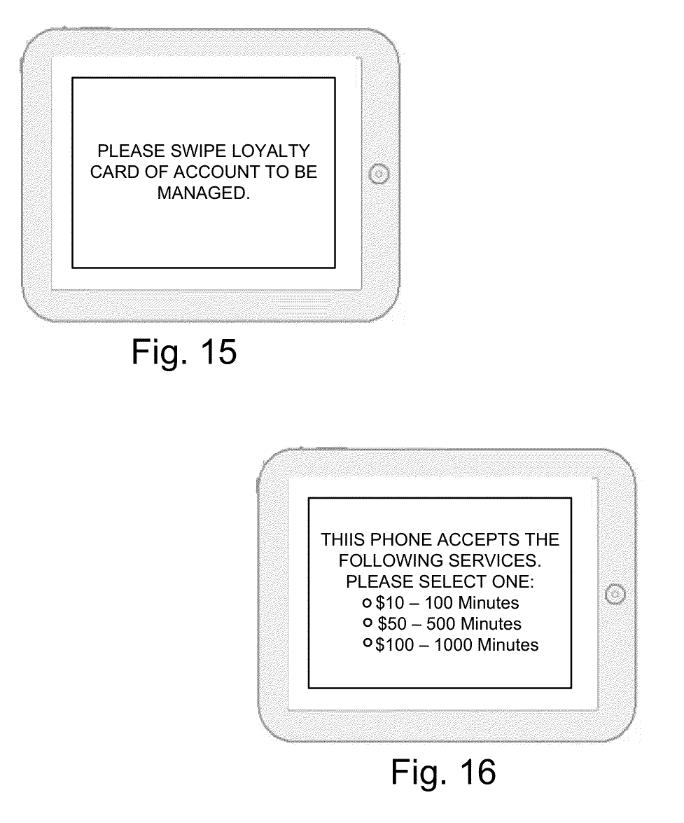

As another example, if the consumer has selected management of an existing prepaid debit card or loyalty card, the application 204 generates a prepaid debit card identification entry request screen (FIG. 14) or a loyalty card identification entry request screen (FIG. 15) instructing the consumer to enter identification information associated with the existing prepaid credit card or loyalty card, respectively. In the particular example shown, identification information is received using the card reader, which is scanned by the consumer. Nevertheless, identification information of the debit card/loyalty card may be received in any suitable manner, such as by entry of account information manually via the debit card identification entry request screen/loyalty card identification entry request screen by the consumer.

In step 406, the application 204 facilitates management of the account between the consumer and the service provider computing device 208. The information may include any type for management of the account, such as authentication information to ensure validity of the account to be managed, query information to receive selective information from the consumer, and/or informative information to convey instructions or advertisements to the consumer regarding the service provided by the consumer item. The application 204 may receive query information for obtaining a selection from among several optional features from the consumer.

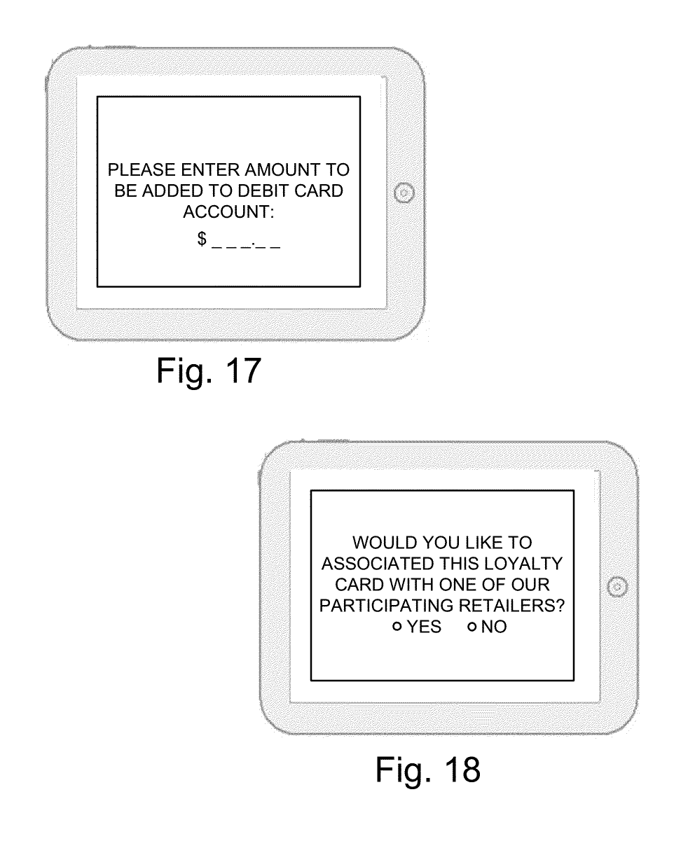

For an example in which the consumer has previously selected management of an account of a communication service, the application 204 generates a prepaid phone consumer input selection screen (FIG. 16) requesting input, from the consumer, to select a particular monetary amount to be contributed to the prepaid phone account. For another example in which the consumer has previously selected management of an account of a prepaid debit card, the application 204 generates a prepaid debit card consumer input selection screen (FIG. 17) requesting input, from the consumer, to select an amount to be contributed to the prepaid debit card account. For yet another example in which the consumer has previously selected management of an account of a loyalty card account, the application 204 generates a loyalty card consumer input selection screen (FIG. 18) requesting input, from the consumer, to select one or more features to be added to the debit card account. The one or more features may include, for example, a fuel rewards program to be added to the account of the loyalty card.

In one embodiment, information for managing the account in addition to one or more rules/policies to be applied to the account are stored in the server 202 such that management of the account is processed within the server 202 and post-processed account management information is transmitted back to the service provider computing device 208 following an interactive management session with the consumer. For example, when the application 204 receives the selection option from the consumer in response to generating the consumer input selection screen (FIG. 16), the application 204 processes this information to modify the account according the consumer's selected entry. In another embodiment, information for managing the account is stored in the service provider computing device 208 such that the application 204 functions as a thin client to receive information from the service provider computing device 208 and generate an interface on the kiosk computing device 103 according to the received information. For example, when the application 204 receives the selection option from the consumer in response to generating the consumer input selection screen (FIG. 16), the application 204 then forwards this information back to the service provider computing device 208 such that the service provider computing device 208 may manipulate the account according to the received input from the consumer.

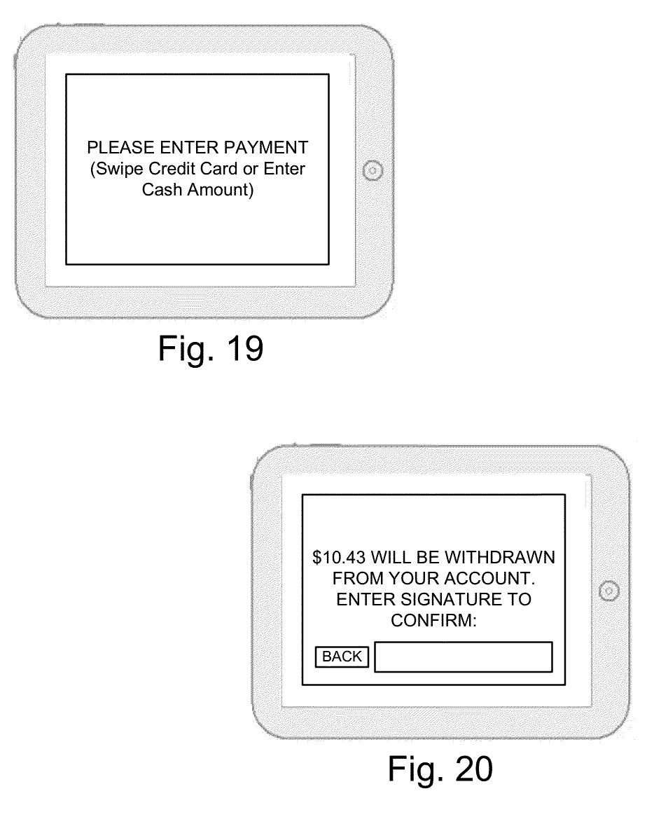

In step 408, the kiosk management application 204 receives payment from the consumer. For example, the payment selection screen may accept payment from the consumer using a technology such GOOGLE WALLET™ or PASSBOOK™ For example, the kiosk management application 204 may generate a payment screen (FIG. 19) requesting that the consumer enter payment for the services selected in step 406. In the particular example shown, application 204 requests payment either by cash or credit card. Nevertheless, it is contemplated that the application 204 may be configured to accept payment from any suitable medium, such as via a bank card, a radio frequency identification tag (RFID) tag, a prepaid debit card, or the like. In general, the application 204 automatically detects which monetary processing unit is used and continues processing a transaction for the account using information from the detected monetary processing unit. For example, if the application 204 detects that money has been entered into the cash processing unit 114, it will receive monetary information from the cash processing unit 114 and credit the account with the appropriate funds accordingly. However, if the application 204 detects that the card reader 112 has detected entry of a stored value card, such as a credit card, the application 204 communicates with the financial account server 222 to process a transaction for payment of the account selections as specified in step 406.

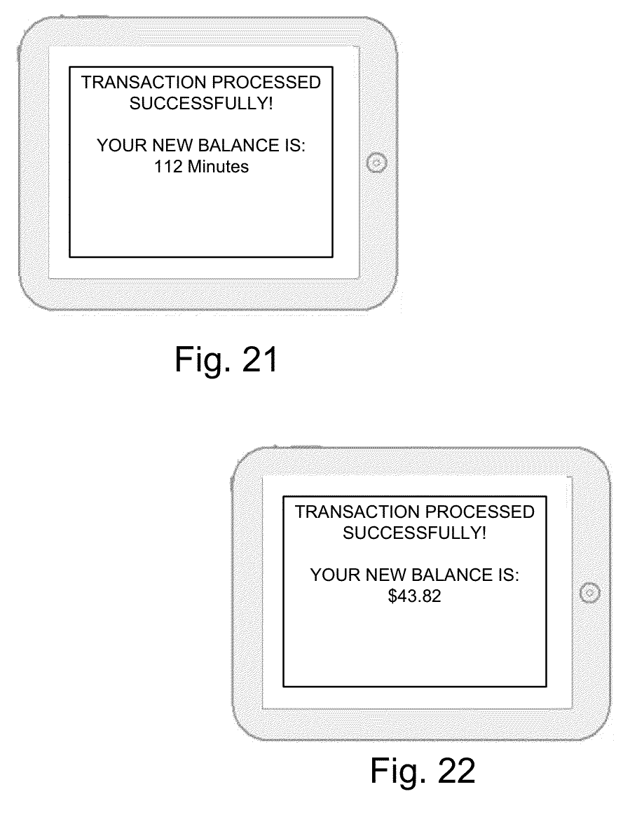

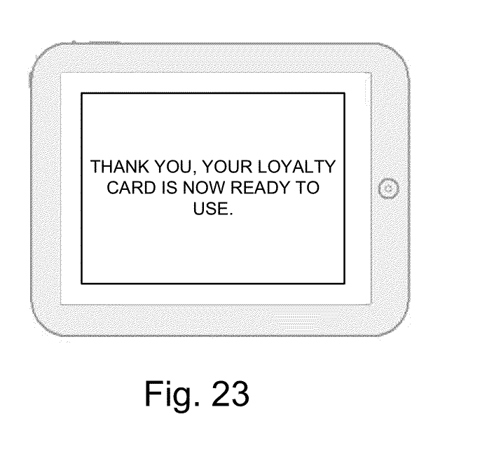

In step 410, the kiosk management application 204 facilitates activation or changes to the account associated with the consumer item. The application 204 settles the account transaction by communicating with a financial account server 210 of the consumer to provide payment for the service by the consumer and with the service provider computing device 208 for activating or otherwise updating changes to the account associated with the service. For example, the application 204, upon detecting input of monetary funds, such as stored value card (e.g., credit card) information via the card reader 112, processes the transaction with the financial account server 222 of the consumer, and generates a confirmation screen (FIG. 20) for receipt of the consumer's signature for settling the transaction or selection of a ‘back’ button for canceling the pending transaction. Upon completion of the prepaid phone, debit card, or loyalty card transaction, the application 204 then generates a prepaid phone confirmation screen (FIG. 21), a debit card confirmation screen (FIG. 22), or loyalty card confirmation screen (FIG. 23), respectively, to show that the transaction has been successfully completed. Additionally, the application 204 may include information indicating detailed information about changes to the account, such as, for example, detailed information regarding a quantity of talk minutes available to the consumer of a mobile phone service.

The application 204 may repeat the above-described steps to manage other accounts for the same consumer or other consumers. Nevertheless, when use of the kiosk account management system is no longer needed or desired, the process ends.

It should be appreciated that the steps described herein are provided only as an example of a process that is performed by the kiosk management application 204 according to the teachings of the present invention, and that the kiosk management application 204 may perform fewer, more, or different types of steps than those described herein. For example, the kiosk management application 204 performs multiple steps described above as a single step, or perform a single step as multiple, distributed steps. As another example, certain steps described herein is performed by other components of the kiosk account management system 200, such as by the computing device 108 used by the consumer, the kiosk management server 208, and/or the financial account server 210 of the consumer.

In one embodiment, the kiosk management application 204 may also possess the capability of locking (e.g., disabling) the computing device 103 in the event that a fault condition occurs or a fraudulent event is detected. For example, if a particular consumer attempts to process the transaction using an invalid credit card for a specified number of times, the kiosk management application 204 may disable the computing device 103, lockdown the screen, and generate an alarm to alert personnel of the potentially fraudulent event.

In another embodiment, the kiosk account management system 100 may be used for display of advertising information or other types of information to the user associated with consumer items without activation and/or modification of any account associated with the consumer items. That is, the kiosk account management system 100 may display information, including interactive information, to the user without affecting or manipulating any account to be associated with consumer items. For example, the kiosk account management system 100 may be configured on a retail display in which prepaid telephones are displayed for sale in which certain prepaid telephone services are advertised on a rotating basis. Additionally, the display may be interactive in that selection buttons may be provided on the display such that, upon selection by a user, the application 204 generates and displays additional information related to the selected content. In this manner, the user may experience an enhanced shopping experience by interacting with the kiosk account management system 100 to gain additional knowledge related to the consumer item to be purchased by the user.

In another embodiment, the kiosk account management system 100 may include one or more security features. The kiosk management server 202 may receive and store images that are received periodically (e.g., every five seconds) or received at certain events using the camera 110 mounted on the kiosk 100. The images may be stored for a specified amount of time such that personnel who administer the use of the kiosk account management system 100 may forensically may obtain facial identification of the fraudulent consumer.

For a particular embodiment in which the computing device 103 is a tablet computer, a specified executable application (i.e., an app) may be used to generate the GUI from which information is received from the consumer. The operating software may be configured as a permissions-based format such that the consumer is only allowed to execute the app for administering the kiosk account management system 100. That is, the consumer is inhibited from executing any other application on the computing device 103. Additionally, the app may be locked (i.e., inhibited from executing) in response to detection of a fraudulent event and/or due to malfunction of the system. The kiosk management server 102 may also include a GUI such that an administrator of the kiosk account management system 100 may remotely access the computing device 103, and have administrative privileges (e.g. super user mode) that can be accessed via a unique key combination (e.g., password access) for servicing, maintaining, or otherwise administering the operation of the computing device 103. The tablet computer may also be physically coupled to a tether or cable to prevent its theft.

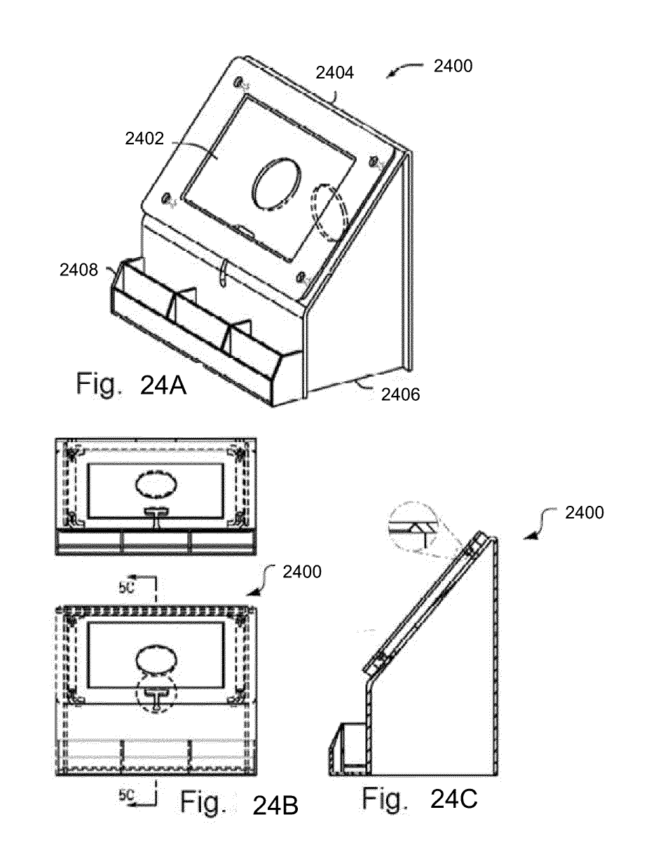

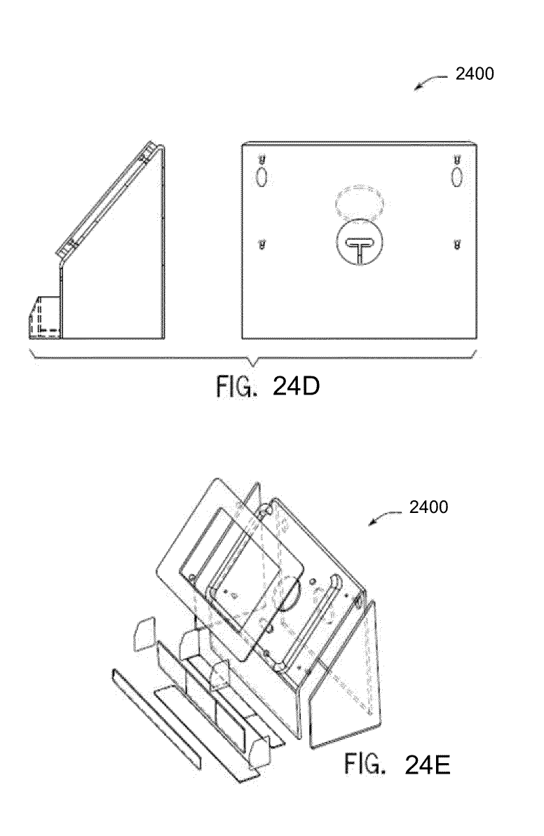

FIGS. 24A through 24E illustrate another example account management kiosk 2400 according to the teachings of the present disclosure. The account management kiosk 2400 includes a computing device 2402 that functions similarly to the computing device 103 as described above with reference to FIG. 1. Additionally, the computing device 2402 functions with the kiosk account management system 220 as described above with reference to FIGS. 2 through 23 in a similar manner as the computing device 103 of FIG. 1. The account management kiosk 2400, however, differs from the account management kiosk 100 of FIG. 1 in that the account management kiosk 2400 includes a counter-top housing 2404 that is to be mounted on a counter-top, such as a table, counter-top, or other suitable elevated support structure.

The counter-top housing 2402 has a bottom end 2406 for support from and/or mounting to a typical counter-top, and is dimensioned such that a consumer may access the GUI in a relatively comfortable manner. In the particular embodiment shown, for example, the counter-top housing 2404 has a height of 10.406 inches, a width of 12.688 inches, and a depth of 5.375 inches. Nevertheless, other embodiments of the counter-top housing 2404 may have other dimensions without departing from the spirit or scope of the present disclosure. For example, a wall-mounted housing, floorstand, or free standing housing may be used.

The counter-top housing 2404 may be made of any suitable material, such as wood, composites, plastic, and/or metal that supports the computing device 2402 in a structurally sound manner. The counter-top housing 102 may also include one or more pockets 2408, shelves, or containers for housing various items including consumer items whose accounts may be managed via the kiosk computing device 103.

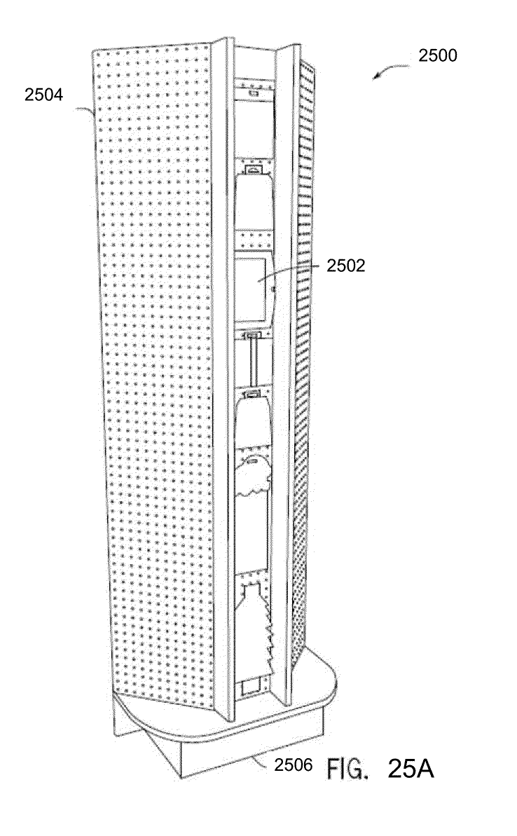

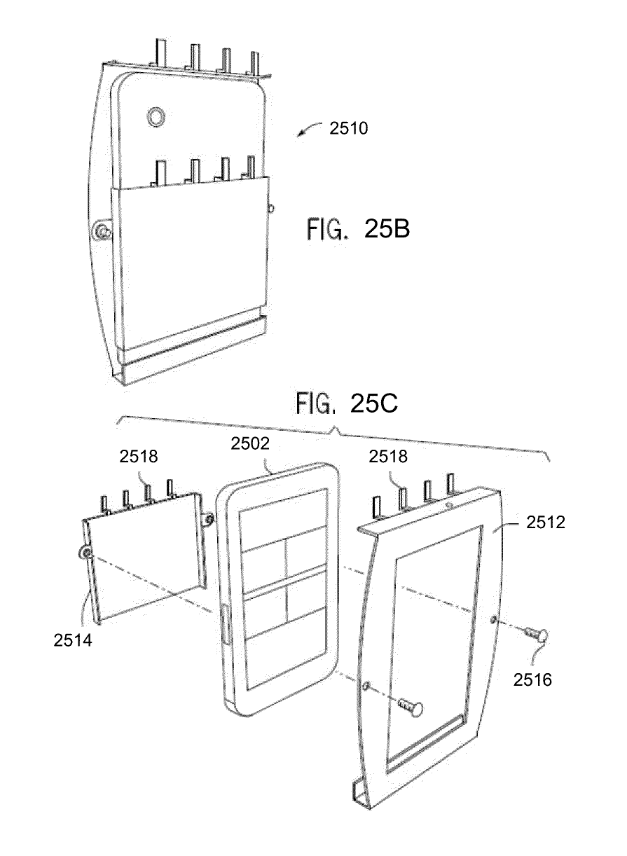

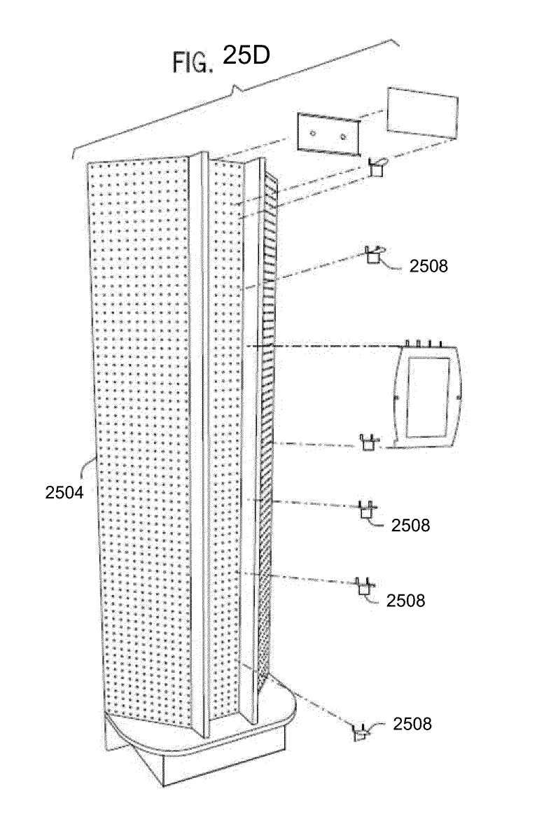

FIGS. 25A through 25C illustrate another example account management kiosk 2500 according to the teachings of the present disclosure. The account management kiosk 2500 includes a computing device 2502 that functions similarly to the computing device 103 as described above with reference to FIG. 1. Additionally, the computing device 2502 functions with the kiosk account management system 200 as described above with reference to FIGS. 2 through 17 in a similar manner as the computing device 103 of FIG. 1. The account management kiosk 2500, however, differs from the account management kiosk 100 of FIG. 1 in that the account management kiosk 2500 includes a retail display housing 2504 that is to display other retail sale items along with the computing device 2502.

The particular retail display housing 2504 as shown has a floorstand-like structure with a bottom end 2506 for support from a floor. In other embodiments, retail display housing 2504 may be dimensioned for support from any suitable surface, such as, for example, a counter-top, a floor, a shelf, or a wall. The retail display housing 2504 may be made of any suitable material, such as wood, plastic, composites, and/or metal, that supports the computing device 2502 in a structurally sound manner. The retail display housing 2504 may also include multiple regularly spaced holes that are designed to accept hooks 2508 for hanging the consumer items as well as other retail sale items related to the consumer items.

The retail display housing 2504 includes a chassis 2510 for securing the computing device 2502 to the retail display housing 2504. The chassis 2510 generally includes a front plate 2512 and a back plate 2514 that securely confine the computing device 2502 therebetween using tamper resistant screws 2516. The front plate 2512 and back plate 2514 include hooks 2518 that, when inserted into holes of the retail display housing 2504, prevent removal of the chassis 2510 from the retail display housing 2504.

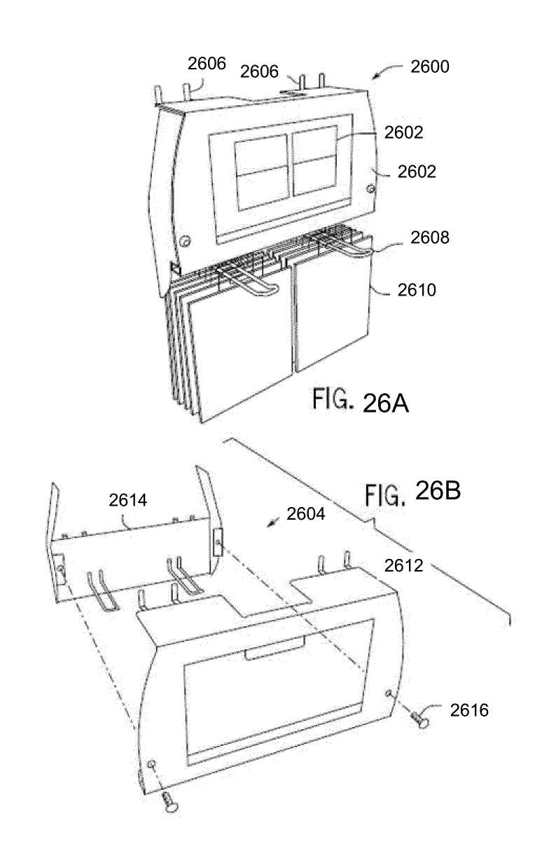

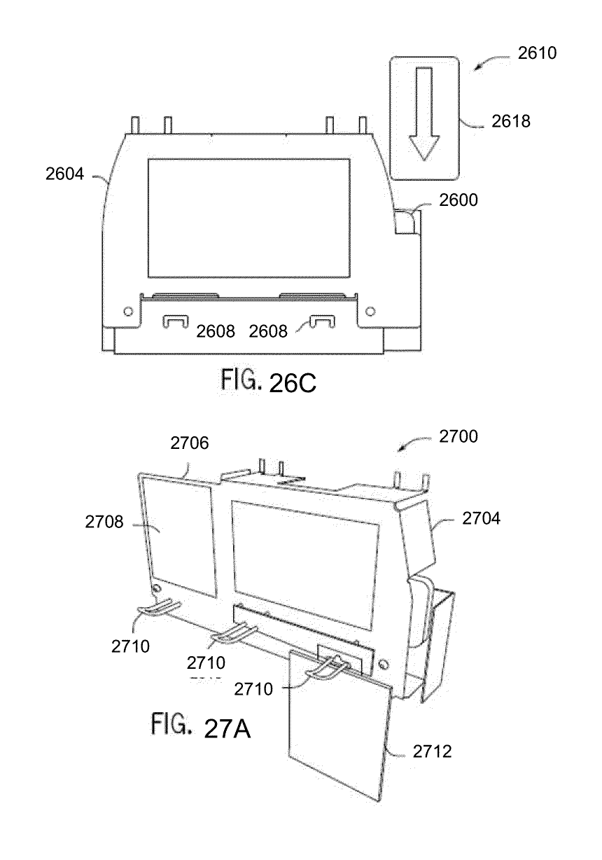

FIGS. 26A through 26C illustrate another example account management kiosk 2600 according to the teachings of the present disclosure. The account management kiosk 2600 houses a computing device 2602 that functions similarly to the computing device 103 as described above with reference to FIG. 1. Additionally, the computing device 2602 functions with the kiosk account management system 200 as described above with reference to FIGS. 2 through 21 in a similar manner as the computing device 103 of FIG. 1. The account management kiosk 2600, however, includes a chassis 2604 that differs from the chassis 2510 of FIG. 25B in that the chassis 2604 supports the computing device 2602 such that its display is oriented in a landscape mode as opposed to the computing device 2510 that has the display of its computing device 2502 oriented in a portrait mode.

The chassis 2604 as shown has a third party display mounting structure with hooks 2606 to be supported from holes in a third party display. The third party display may be any retail display structure that is configured to display retail items. Examples of such third party displays may include, for example, the retail display housing 2504 of FIGS. 25A through 25C having a peg-board like structure for placement of various retail items. In other embodiments, the chassis 2604 may include any type of securement mechanism for mounting to any wall. The chassis 2604 may be hung from any suitable wall structure. For example, the chassis 2604 may be hung at an elevation that conforms to the Americans with Disabilities Act of 1990 (ADA) requirements.

The computing device 2604 may be any type and size. In one example, the computing device 2604 is a tablet computer having a 7.0 inch display size. A tablet computer having such a size may be well accommodated into certain consumer item display corner posts. Nevertheless, it is contemplated that a computer having any sized display may be implemented with the account management kiosk 2600. For example, the chassis 2604 may be sized to accommodate a tablet computer having a 8.0 inch display size or a 11.0 inch display size.

The chassis 2604 may be made of any suitable material, such as wood, plastic, composites, and/or metal that supports the computing device 2602 on a wall in a structurally sound manner. The retail display housing 2602 also includes two pegs 2608 for supporting and displaying consumer items 2610 in pendant fashion proximate to the computing device 2602. Nevertheless, any quantity of pegs 2608 may be used without departing from the spirit and scope of the invention.

The chassis 2604 with a front plate 2612 and a back plate 2614 for secure confinement of the retailer computing device 2602 using one or more tamper resistant screws 2616 such that the computing device 2603 is securely mounted to an outer surface of a wall on which the retail display housing 2600 is hung. The front plate 2612 includes a display hole to provide visibility of the display from in front of the retail display structure. Additionally, the tamper resistant screws 2616 may be configured on the chassis 2604 such that they may also extend through a wall on which the chassis 2604 is hung to secure the chassis 2604 to the wall.

The chassis 2604 has a depth D that supports the computing device 2602 at a specified distance in front of the wall on which it is mounted. In the particular embodiment shown, the chassis 2604 has a depth of approximately 2.0 inches for supporting the computing device 2602 in front of a wall on which it is mounted. Nevertheless, other embodiments of the chassis 2604 may have any desired depth D without departing from the spirit or scope of the present disclosure. Embodiments that support the computing device 2604 a specified depth in front of a wall may provide an advantage in that the computing device 2602 may be maintained closer to customers for increased eye appeal. Additionally, the chassis 2604 requires relatively little floor space at a retail location; that is, it may be configured on an existing display shelf or other structure in a retail location without the use of any additional support structure that consumes floor space.

In one embodiment, the chassis 2604 provides a closed frame around the computing device 2604 such that the top and the back of the computing device 2604 is covered, thus restricting access to these portions of the computing device 2604. Additionally, the chassis 2604 is formed such that, when the computing device 2604 is housed therein, only certain physical ports of the computing device 2604 are accessible. That is, the front plate 2612 and/or back plate 2614 may include one or more tabs for concealing physical ports that are to be restricted from access when the computing device 2604 is housed in the chassis 2604. For example, the chassis 2604 may include a tab or other physical feature that covers certain critical buttons of the computing device 2602, such as its “home” button or power button, to prevent their actuation.

As best shown in FIG. 26C, a card reader 2618 is configured on the chassis 2604 for receiving identification information associated with a stored value card, such as a prepaid debit card to be activated and/or replenished with funds by a consumer, and financial information associated with a financial account of the consumer, such as credit card information provided by the consumer. For example, FIG. 26C shows a prepaid debit card 2610 in the process of being swiped through the card reader 2618. As shown, the chassis 2604 has an overall width of 9.750 inches with a width of 10.915 inches for providing clearance for swiping the stored value card 2610 and/or credit card of the consumer. Nevertheless, the chassis 2604 may have any suitable dimensional constraints for providing sufficient clearance for its display and for swiping a stored value card and/or credit card of a consumer. In one particular example, the card reader 2618 may be configured on the front surface of the chassis 2604 such that additional clearance width is not necessary for swiping the stored value card and/or credit card of the consumer.

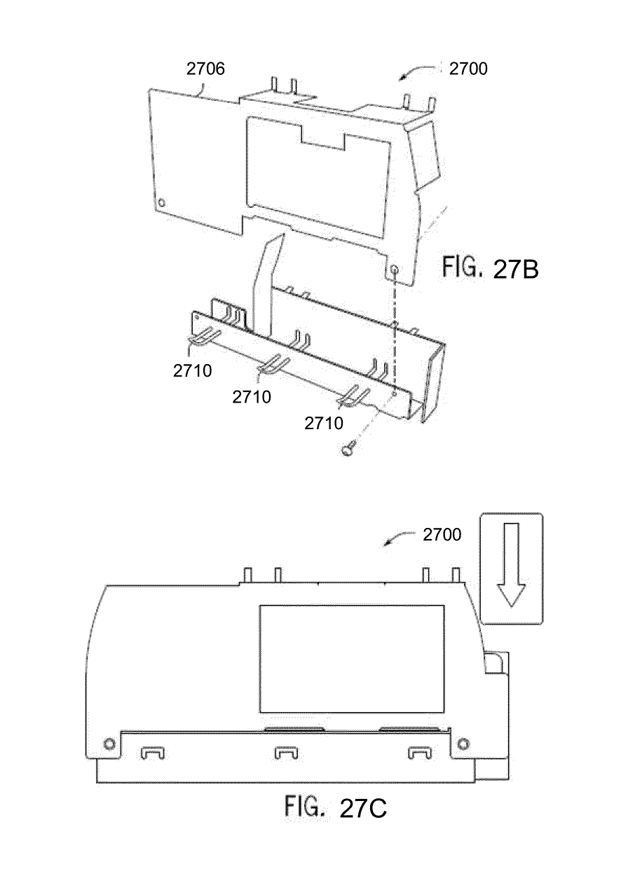

FIGS. 27A through 27C illustrate yet another example account management kiosk 2700 according to the teachings of the present disclosure. The account management kiosk 2700 includes a computing device 2702 that functions similarly to the computing device 103 as described above with reference to FIG. 1. Additionally, the computing device 2702 functions with the kiosk account management system 200 as described above with reference to FIGS. 2 through 17 in a similar manner as the computing device 103 of FIG. 1. The account management kiosk 2700 also includes a chassis 2704 for housing the computing device 2702 in a manner similar to the chassis 2604 of the account management kiosk 2600 of FIGS. 26A through 26C. The chassis 2704 differs, however, in that it includes a front plate with a generally flat-shaped display region 2706 for releasable mounting of a promotional graphic image 2708 thereon. The chassis 2704 of the kiosk 2700 also differs from the chassis 2600 of the kiosk 2600 of FIGS. 26A through 26C in that three hooks 2710 are provided for support of unactivated gift cards 2712 on the kiosk 2700.

Preferably, the graphic image 2708 includes advertising content that promotes the sales of gift cards 2712 displayed on the kiosk 2700. For example, the graphic image 2708 includes an animated image and overlaying text portraying some positive trait of at least one of the gift cards 2712 displayed on the kiosk 2700. The graphic image 2708 as shown is formed on a generally rectangular-shaped piece of card stock that is mounted to the display region 2706 using releasable adhesive or other releasable attachment means.

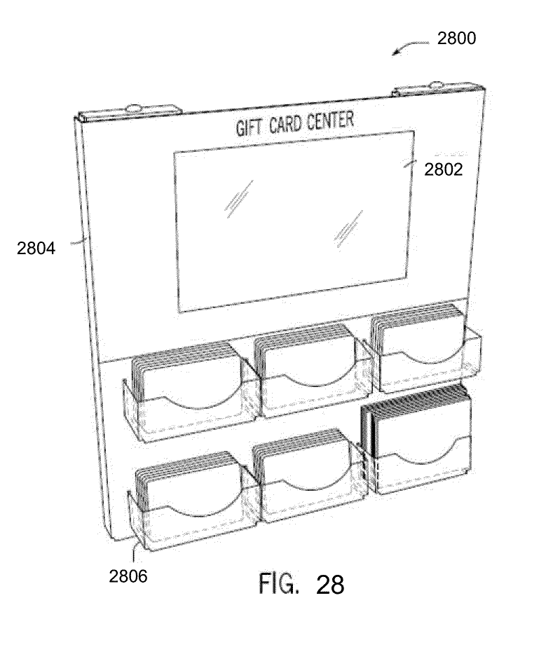

FIG. 28 illustrates yet another example account management kiosk 2800 according to the teachings of the present disclosure. The account management kiosk 2800 houses a computing device 2802 that functions similarly to the computing device 2502 as described above with reference to FIGS. 25A through 25C. Additionally, the computing device 2802 functions with the kiosk account management system 200 as described above with reference to FIGS. 2 through 21 in a similar manner as the computing device 103 of FIG. 1. The account management kiosk 2800 differs however from the account management kiosk 2500 of FIGS. 25A through 25C in that the account management kiosk 2800 includes a generally rectangular-shaped housing 2804 configured to be hung from a wall.

The particular account management kiosk 2804 as shown has a wall-mount structure adapted for hanging from a wall using any suitable mounting mechanism. For example, the kiosk 2804 includes holes in the housing 2804 that are configured to accept anchors or screws that may be secured to a wall. Another example mounting mechanism includes one or more pegs that are shaped for insertion into a track mounting system or other system having a slot or depression that entraps the pegs. Other example of suitable mounting mechanisms may include adhesives, suction cups, magnets, zip ties, and the like.

The account management kiosk 2804 includes one or more pockets 2806 for holding stored value cards 2808 is close proximity to the computing device 2802. In other embodiments, the account management kiosk 2804 includes any type of mechanism for holding and displaying any type of consumer item such as described above. The pockets 2806 are formed of a 0.060 inch thick sheet of transparent material, such as glycol-modified polyethylene terephthalate (PETG), although any suitable material may be used. Each pocket is approximately 2.0 inches deep for securely holding the stored value cards while allowing partial exposure so that they may be easily removed by consumers.

Several embodiments including the floorstand housing, the counter-top housing, the retail display unit, the wall mount housing, and the third party attachment housing have been described above for providing a structure for facilitating a kiosk-based account management system for consumer items. Nevertheless, it should be understood that the afore-described housings may have additional, fewer, or different features than described herein. For example, other embodiments of the counter-top housing, the retail display unit, the wall mount housing, or the third party attachment housing may have different dimensions than the embodiments described above. As another example, other embodiments of the counter-top housing, the retail display unit, the wall mount housing, or the third party attachment housing may have more than one computing device (e.g., two or more computing devices) configured thereon for displaying advertising content for consumers. As yet another example, other embodiments of the counter-top housing, the retail display unit, the wall mount housing, or the third party attachment housing may include one, both, or none of the card reader 112, and/or cash processing unit 114 that is used for processing transactions with consumers who use the account management kiosk.

Those skilled in the art will appreciate that variations from the specific embodiments disclosed above are contemplated by the invention. The invention should not be restricted to the above embodiments, but should be measured by the following claims.

What is claimed is:

1. A kiosk comprising:
a housing structure to hold and display one or more consumer items; and
a kiosk computing device to be housed and supported by the housing structure and having a display screen for providing interaction with a consumer, the kiosk computing device to generate a graphical user interface (GUI) to the display screen to:
receive, from the consumer, account information associated with a service provided by at least one of the consumer items using an interactive video segment;
facilitate management of the account using the account information with a service provider computing device administered by a provider of the service;
receive, from the service provider computing device, interactive video segment information for customizing the interactive video segment; and
customize the interactive video segment according to the received interactive video segment information.

2. The kiosk of claim 1, wherein the kiosk computing device is executable to:
receive payment information for the service using a monetary processing unit configured on the kiosk; and
facilitate payment for the service with the service provider computing device using the received payment information.

3. The kiosk of claim 1, wherein the account comprises a prepaid phone account and the service comprises a mobile phone service.

4. The kiosk of claim 3, wherein the kiosk computing device is executable to facilitate activation of the prepaid phone account.

5. The kiosk of claim 3, wherein the kiosk computing device is executable to facilitate renewal of the prepaid phone account.

6. The kiosk of claim 1, wherein the account comprises a prepaid debit card and service comprises a monetary transaction service provided by the prepaid debit card.

7. The kiosk of claim 1, wherein the account comprises a loyalty card account and the service comprises one or more discount offer services provided by the loyalty card account.

8. The kiosk of claim 1, wherein the kiosk computing device is executed to communicate with a kiosk management server to facilitate management of the account.

9. The kiosk of claim 9, wherein the kiosk management server is executable to manage one or more functions of the kiosk computing device.

10. The kiosk of claim 1, wherein the kiosk computing device communicates directly with the service provider computing device to facilitate management of the account.

11. The kiosk of claim 1, wherein the housing structure comprises a counter-top housing with a bottom end to be mounted on a counter-top.

12. The kiosk of claim 1, wherein the housing structure comprises a floorstand housing with a bottom end to be mounted on a floor.

13. The kiosk of claim 1, wherein the housing structure comprises a wall-mount housing configured to be mounted on a wall.

14. The kiosk of claim 1, wherein the housing structure comprises a retail display unit to display other sale items related to stored value cards.

15. The kiosk of claim 1, wherein the housing structure comprises a retail display housing configured to be mounted on a third party display.

16. The kiosk of claim 1, wherein the kiosk computing device is executed to receive, from the service provider computing device, video advertising segment information for customizing a video advertising segment that is played on the kiosk computing device; and
customize the video advertising segment according to the received video advertising segment information.

17. The kiosk of claim 1, wherein the provider computing device is executed to:
obtain sales information associated with sales of the service performed by the kiosk computing device; and
display the obtained sales information.

18. The kiosk of claim 17, wherein the provider computing device is executed to:
obtain video advertising content information associated with video advertising content that is played on the kiosk computing device; and
display the obtained video advertising information along with the obtained sales information.

19. A kiosk account management system comprising:
a kiosk management server comprising at least one memory and at least one processor, the at least one memory comprising computer executable instructions configured to, when executed by the processor:
receive account information from a kiosk computing device configured in a kiosk, the account information associated with a service provided by at least one of a plurality of consumer items held and displayed on the kiosk; and
facilitate management of the account using the account information with a service provider computing device administered by a provider of the service;
receive, from the service provider computing device, interactive video segment information for customizing the interactive video segment; and
customize the interactive video segment according to the received interactive video segment information.

20. The system of claim 19, wherein the kiosk computing device is executable to:
receive payment information for the service using a monetary processing unit configured on the kiosk; and
facilitate payment for the service with the service provider computing device using the received payment information.

21. The system of claim 19, wherein the account comprises a prepaid phone account and the service comprises a mobile phone service.

22. The system of claim 21, wherein the kiosk management server is executed to facilitate activation of the prepaid phone account.

23. The system of claim 20, wherein the kiosk computing device is executed to facilitate renewal of the prepaid phone account.

24. The system of claim 20, wherein the account comprises a prepaid debit card and service comprises a monetary transaction service provided by the prepaid debit card.

25. The system of claim 19, wherein the account comprises a loyalty card account and the service comprises one or more discount offer services provided by the loyalty card account.

26. The system of claim 25, wherein the kiosk management server is executable to manage one or more functions of the kiosk computing device.

27. The system of claim 19, wherein the kiosk management server is executable to:
obtain location information associated a location of the kiosk computing device; and
disable operation of the kiosk computing device when the location information indicates that the kiosk computing device has traveled outside of a specified boundary.

28. The system of claim 19, wherein the kiosk management server is executable to:
obtain connectivity information associated a communication connection between the kiosk computing device and the kiosk management server; and
generate an alert message when the connectivity information indicates that the connection has been lost.

29. A method comprising:
providing a kiosk comprising a housing structure to hold and display one or more consumer items, and a kiosk computing device to be housed and supported by the housing structure and having a display screen for providing interaction with a consumer;
receiving, from the kiosk computing device, account information associated with a service provided by at least one of the consumer items from the consumer; and
facilitating management of the account using the account information with a service provider computing device administered by a provider of the service;
receiving, from the service provider computing device, interactive video segment information for customizing the interactive video segment; and
customizing the interactive video segment according to the received interactive video segment information.

30. The method of claim 29, further comprising:
receiving, using the kiosk computing device, payment information for the service using a monetary processing unit configured on the kiosk; and
facilitating payment for the service with the service provider computing device using the received payment information.

31. The method of claim 29, further comprising facilitating activation of a prepaid phone account, wherein the account comprises the prepaid phone account and the service comprises a mobile phone service.

32. The method of claim 31, further comprising facilitating renewal of the prepaid phone account.

33. The method of claim 29, further comprising facilitating activation of a prepaid debit card account, wherein the account comprises the prepaid debit card account and the service comprises a monetary transaction service provided by the prepaid debit card.

34. The method of claim 33, further comprising facilitating renewal of the prepaid debit card account.

35. The method of claim 29, wherein the account comprises a loyalty card account and the service comprises one or more discount offer services provided by the loyalty card account.

36. The method of claim 29, further comprising communicating with a kiosk management server to facilitate management of the account.

37. The method of claim 36, further comprising managing one or more functions of the kiosk computing device using the kiosk management server.

38. The method of claim 29, further comprising:
receiving, from the service provider computing device, video advertising segment information for customizing a video advertising segment that is played on the kiosk computing device; and
customizing the video advertising segment according to the received video advertising segment information.

39. The method of claim 29, further comprising:
obtaining sales information associated with sales of the service performed by the kiosk computing device; and
displaying the obtained sales information.

40. The method of claim 40, further comprising:
obtaining video advertising content information associated with video advertising content that is played on the kiosk computing device; and
displaying the obtained video advertising information along with the obtained sales information.
